(19) United States
(12) Patent Application Publication
(10) Pub. No.: US 2017/0160429 A1
(43) Pub. Date: Jun. 8, 2017

(54) GEOMECHANICAL DISPLACEMENT BOUNDARY CONDITIONS

(71) Applicant: Schlumberger Technology Corporation, Sugar Land, TX (US)

(72) Inventors: Thomas Berard, Bracknell (GB); Peter Welsh, Abingdon (GB); Andrew Pearce, Abingdon (GB)

(21) Appl. No.: 14/960,045

(22) Filed: Dec. 4, 2015

(51) Int. Cl. G01V 99/00; G06F 17/10

(52) U.S. Cl. CPC G01V 99/005; G06F 17/10

(57) ABSTRACT

A method can include receiving a model of a geologic environment; imposing displacement boundary conditions on at least one boundary of the model; and solving for equilibrium stress for the model subject to the displacement boundary conditions.

### BACKGROUND

A geologic formation can deform over time, for example, responsive to gravity, one or more operations, etc.

### SUMMARY

In accordance with some embodiments, a method includes receiving a model of a geologic environment; imposing displacement boundary conditions on at least one boundary of the model; and solving for equilibrium stress for the model subject to the displacement boundary conditions.

In some embodiments, an aspect of a method includes displacement boundary conditions that are based at least in part on two strain values and based at least in part on one azimuth value.

In some embodiments, an aspect of a method includes displacement boundary conditions that are imposed on at least one lateral boundary of a model that is between a bottom face and a top face of the model.

In some embodiments, an aspect of a method includes displacement boundary conditions that include a gradient displacement boundary condition.

In some embodiments, an aspect of a method includes displacement boundary conditions that include a displacement function boundary condition.

In some embodiments, an aspect of a method includes a model that includes cells defined by nodes, where at least a portion of the nodes are boundary nodes and where horizontal displacements are assigned as displacement boundary conditions to at least some of the boundary nodes.

In some embodiments, an aspect of a method includes a model that includes cells defined by nodes, where at least a portion of the nodes are boundary nodes and where the displacement boundary conditions include horizontal displacements specified by at least one final surface as a solution destination for at least a portion of the boundary nodes where, for example, the model can include lateral sides and where the at least one final surface includes a final surface for each of the lateral sides.

In some embodiments, an aspect of a method includes displacement boundary conditions that specify at least one displacement value for horizontal displacement of at least a portion of at least one boundary of a model.

In some embodiments, an aspect of a method includes displacement boundary conditions that specify amounts of displacement for at least some corners of a model.

In some embodiments, an aspect of a method includes a reference where displacement boundary conditions specify at least one displacement that is defined with respect to the reference where, for example, the reference is a reference point that is fixed horizontally or a reference point that is fixed horizontally and fixed vertically.

In some embodiments, an aspect of a method includes performing an inversion based at least in part on measured data to determine at least one displacement value and, for example, imposing at least one of the at least one displacement value as a displacement boundary condition value.

In some embodiments, an aspect of a method includes a model that includes dimensions in a three-dimensional coordinate system that include a depth dimension substantially aligned with a direction of Earth's gravity.

In some embodiments, an aspect of a method includes displacement boundary conditions that are imposed horizontally.

In some embodiments, an aspect of a method includes displacement boundary conditions include a function with respect to a depth dimension.

In accordance with some embodiments, a system includes a processor; memory operatively coupled to the processor; and instructions stored in the memory and executable by the processor to instruct the system to: receive a model of a geologic environment; impose displacement boundary conditions on at least one boundary of the model; and solve for equilibrium stress for the model subject to the displacement boundary conditions.

In some embodiments, a system includes instructions stored in memory and executable by a processor to instruct the system to determine one or more of displacement boundary conditions based at least in part on two strain values and based at least in part on one azimuth value.

In accordance with some embodiments one or more computer-readable storage media can include computer-executable instructions to instruct a computing system where the instructions include instructions to: receive a model of a geologic environment; impose displacement boundary conditions on at least one boundary of the model; and solve for equilibrium stress for the model subject to the displacement boundary conditions.

In some embodiments instructions can include computer-executable instructions to instruct a computing system to determine one or more displacement boundary conditions based at least in part on two strain values and based at least in part on one azimuth value.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for modeling a geologic environment and various equipment associated with the geologic environment;

FIG. 2 illustrates an example of a sedimentary basin, an example of a method, an example of a formation, an example of a borehole, an example of a convention and an example of a system;

FIG. 3 illustrates an example of a tectonic regime;

FIG. 4 illustrates an example of a model of a geologic environment and associated information;

FIG. 5 illustrates examples of information and examples of sources of information;

FIG. 6 illustrates examples of geologic environments;

FIG. 7 illustrates an example of a method;

FIG. 8 illustrates an example of a method;

FIG. 9 illustrates an example of a method and example plots of solutions with respect to different types of boundary conditions;

FIG. 10 illustrates an example of a graphical user interface, examples of equations and an example of a method;

FIG. 11 illustrates example plots of a model of a geologic environment;

FIG. 12 illustrates an example plot of a model of a geologic environment;

FIG. 13 illustrates an example plot of a model of a geologic environment and example scenarios;

FIG. 14 illustrates an example of a model in a Cartesian coordinate system;

FIG. 15 illustrates an example of a plot of strain associated with the model of FIG. 14;

FIG. 16 illustrates an example of a plot of displacement with respect to the model of FIG. 14;

FIG. 17 illustrates an example of a plot of displacement with respect to a portion of the model of FIG. 14;

FIG. 18 illustrates an example of a method, examples of conditions and an example of a model; and

FIG. 19 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, a geologic formation can deform over time. Deformation may effect one or more field operations (e.g., drilling, casing, cementing, measuring, production, injection, etc.) and may effect equipment deployed in a borehole or to be deployed in a borehole (e.g., whether cased, uncased, etc.).

As an example, a geomechanical simulation of a modeled geologic environment can provide information germane to how material in the geologic environment deforms. Further, where a geologic environment includes a reservoir, a reservoir simulation can provide information germane to material deformation. For example, consider simulating a reservoir where one or more wells inject fluid into and/or produce fluid from the reservoir over some period of time.

As an example, a geologic environment may include a plurality of reservoirs. In such an example, one or more of the reservoirs may be modeled. As an example, a geomechanical model may span at least a portion of a first reservoir and at least a portion of a second reservoir. In such an example, movement of fluid of the first reservoir and/or movement of fluid of the second reservoir may be analyzed with respect to geomechanics. For example, production of fluid of the first reservoir may result in compaction of reservoir rock of the first reservoir that may affect rock associated with the second reservoir. For example, the overburden of the first reservoir may be affected in a manner that also has an effect on the second reservoir. As an example, a geomechanical model may be coupled to a plurality of reservoir models. In such an example, a geomechanics modeling framework that models a geologic environment may be operatively coupled with a reservoir modeling framework or reservoir modeling frameworks where more than one reservoir may be modeled (e.g., as being within the geologic environment).

As an example, where multiple reservoirs exist, wells may extend to each of the reservoirs. As an example, deformation of a reservoir may have an impact on one or more other reservoirs in a geologic environment that includes multiple reservoirs. As an example, reservoirs may be “stacked”, for example, one reservoir may be at a first depth (e.g., first depth range) and another reservoir may be at a second depth (e.g., a second depth range). A field development plan may aim to develop reservoirs separately and/or in a coordinated manner.

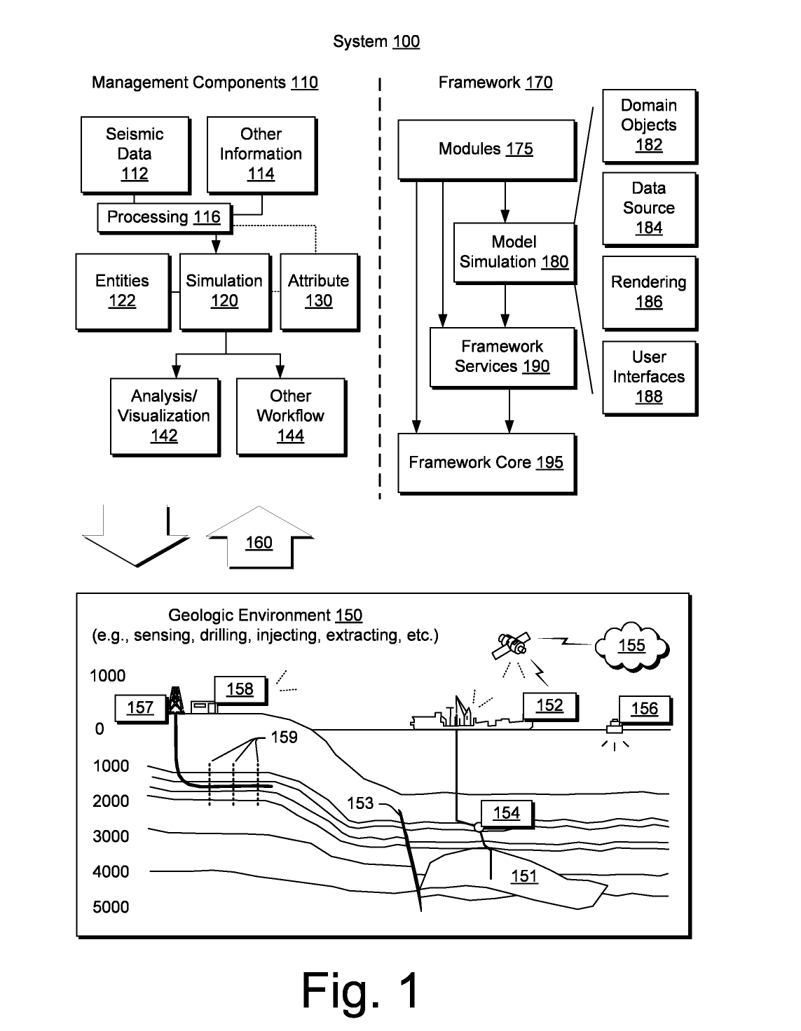

FIG. 1 shows an example of a system 100 that includes various management components 110 to manage various aspects of a geologic environment 150 (e.g., an environment that includes a sedimentary basin, a reservoir 151, one or more fractures 153, etc.). For example, the management components 110 may allow for direct or indirect management of sensing, drilling, injecting, extracting, producing, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities, geological objects or other objects such as wells, surfaces, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT™ .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE® reservoir simulator (Schlumberger Limited, Houston Texas), the INTERSECT® reservoir simulator (Schlumberger Limited, Houston Texas), etc. As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, well engineers, reservoir engineers, etc.) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET™ tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization. Such a model may include one or more grids.

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and that may be intersected by a fault 153. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workflow may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

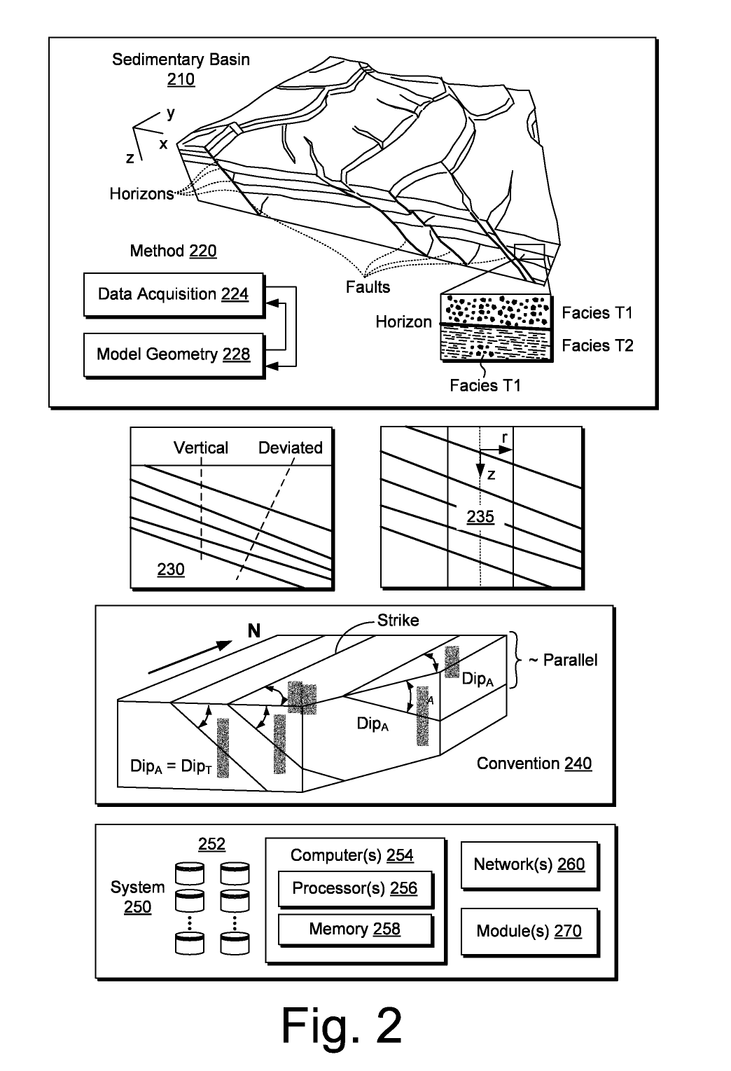

FIG. 2 shows an example of a sedimentary basin 210, an example of a method 220 for model building (e.g., for a simulator, etc.), an example of a formation 230, an example of a borehole 235 in a formation, an example of a convention 240 and an example of a system 250.

As an example, reservoir simulation, petroleum systems modeling, etc. may be applied to characterize various types of subsurface environments, including environments such as those of FIG. 1.

In FIG. 2, the sedimentary basin 210, which is a geologic environment, includes horizons, faults and facies formed over some period of geologic time. These features are distributed in two or three dimensions in space, for example, with respect to a Cartesian coordinate system (e.g., x, y and z) or other coordinate system (e.g., cylindrical, spherical, etc.). As shown, the model building method 220 includes a data acquisition block 224 and a model geometry block 228. Some data may be involved in building an initial model and, thereafter, the model may optionally be updated in response to model output, changes in time, physical phenomena, additional data, etc. As an example, data for modeling may include one or more of the following: depth or thickness maps and fault geometries and timing from seismic, remote-sensing, electromagnetic, gravity, outcrop and well log data. Furthermore, data may include depth and thickness maps stemming from facies variations (e.g., due to seismic unconformities) assumed to following geological events (“iso” times) and data may include lateral facies variations (e.g., due to lateral variation in sedimentation characteristics).

To proceed to modeling of geological processes, data may be provided, for example, data such as geochemical data (e.g., temperature, kerogen type, organic richness, etc.), timing data (e.g., from paleontology, radiometric dating, magnetic reversals, rock and fluid properties, etc.) and boundary condition data (e.g., heat-flow history, surface temperature, paleowater depth, etc.).

In basin and petroleum systems modeling quantities such as temperature, pressure and porosity distributions within the sediments may be modeled by solving partial differential equations (PDEs) using a finite element method (e.g., or other numerical technique). Modeling may also model geometry with respect to time, for example, to account for changes stemming from geological events (e.g., deposition of material, erosion of material, shifting of material, etc.).

A commercially available modeling framework marketed as the PETROMOD® framework (Schlumberger Limited, Houston, Tex.) includes features for input of various types of information (e.g., seismic, well, geological, etc.) to model evolution of a sedimentary basin.

As shown in FIG. 2, the formation 230 includes a horizontal surface and various subsurface layers. As an example, a borehole may be vertical. As another example, a borehole may be deviated. In the example of FIG. 2, the borehole 235 may be considered a vertical borehole, for example, where the z-axis extends downwardly normal to the horizontal surface of the formation 230.

As to the convention 240 for dip, as shown, the three dimensional orientation of a plane can be defined by its dip and strike. Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 240 of FIG. 2, various angles φ indicate angle of slope downwards, for example, from an imaginary horizontal plane (e.g., flat upper surface); whereas, dip refers to the direction towards which a dipping plane slopes (e.g., which may be given with respect to degrees, compass directions, etc.). Another feature shown in the convention of FIG. 2 is strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 240 of FIG. 2). True dip is the dip of a plane measured directly perpendicular to strike (see, e.g., line directed northwardly and labeled “strike” and angle α₉₀) and also the maximum possible value of dip magnitude. Another term is “apparent dip” (see, e.g., Dip_{A} in the convention 240 of FIG. 2). Apparent dip may be the dip of a plane as measured in any other direction except in the direction of true dip (see, e.g., φ_{A} as Dip_{A} for angle α); however, it is possible that the apparent dip is equal to the true dip (see, e.g., φ as Dip_{A}=Dip_{T} for angle α₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 240 of FIG. 2, the dip of a plane as seen in a cross-section perpendicular to the strike is true dip (see, e.g., the surface with φ as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 240 of FIG. 2, apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. In such an example, the resulting dips are called relative dips and may find use in interpreting sand body orientation.

A convention such as the convention 240 may be used with respect to an analysis, an interpretation, an attribute, etc. (see, e.g., various blocks of the system 100 of FIG. 1). As an example, various types of features may be described, in part, by dip (e.g., sedimentary bedding, faults and fractures, cuestas, igneous dikes and sills, metamorphic foliation, etc.).

Seismic interpretation may aim to identify and/or classify one or more subsurface boundaries based at least in part on one or more dip parameters (e.g., angle or magnitude, azimuth, etc.). As an example, various types of features (e.g., sedimentary bedding, faults and fractures, cuestas, igneous dikes and sills, metamorphic foliation, etc.) may be described at least in part by angle, at least in part by azimuth, etc.

As shown in FIG. 2, the system 250 includes one or more information storage devices 252, one or more computers 254, one or more networks 260 and one or more modules 270. As to the one or more computers 254, each computer may include one or more processors (e.g., or processing cores) 256 and memory 258 for storing instructions (e.g., modules), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252.

As an example, the one or more modules 270 may include instructions (e.g., stored in memory) executable by one or more processors to instruct the system 250 to perform various actions. As an example, the system 250 may be configured such that the one or more modules 270 provide for establishing the framework 170 of FIG. 1 or a portion thereof. As an example, one or more methods, techniques, etc. may be performed using one or more modules, which may be, for example, one or more of the one or more modules 270 of FIG. 2.

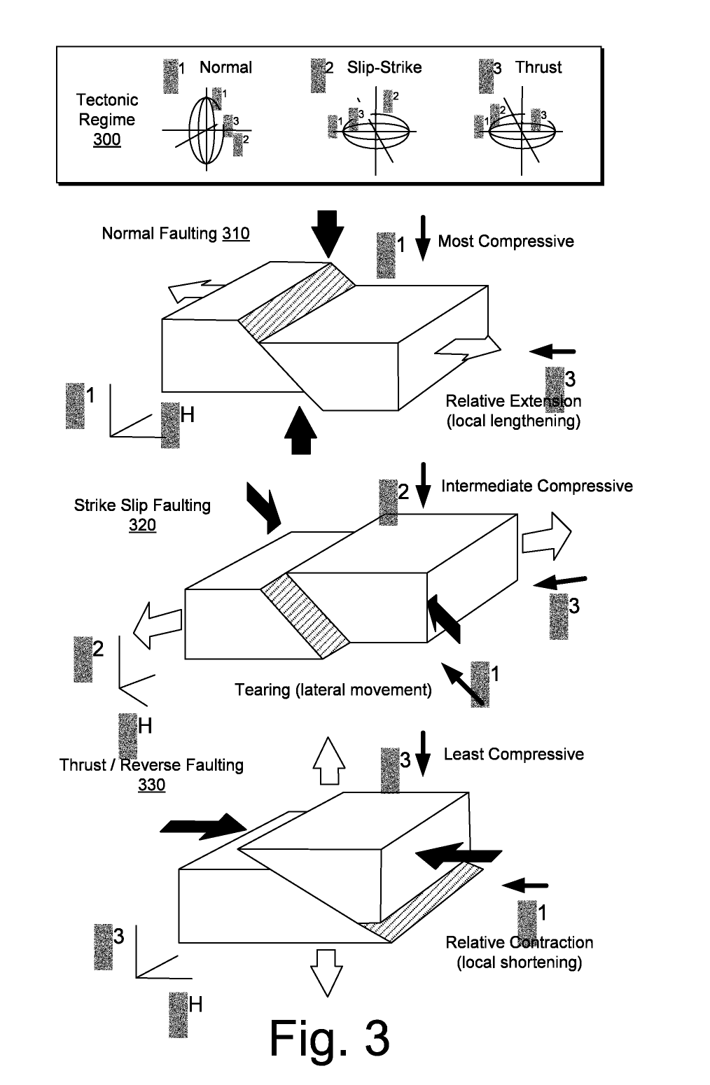

FIG. 3 shows an example of a tectonic regime 300 and examples of normal faulting 310, strike slip faulting 320 and thrust or reverse faulting 330. Stress may be defined, for example, as force per unit area acting on a plane. In a solid body, for example, a stress state at a point in the solid body may be described by orientations and magnitudes of three stresses called principal stresses, which are oriented perpendicular to each other (e.g., orthogonal to each other).

As shown in FIGS. 3, 61, 62 and 63 are compressive or tensile principal stresses where, in magnitude, 1>2>3. As an example, about a point, the three principal stresses may be shown, or represented, as an ellipsoid where the magnitude of each component defines a maximum along a respective one of the three orthogonal axes. Compressive stress and shortening strain are considered positive in rock mechanics and structural geology because in the Earth the three principal stresses tend to be compressive (e.g., except around underground voids such as caves, very near to the Earth's surface, etc.).

The tectonic regime 300 may be defined by considering one axis being vertical. For example, a normal fault regime corresponds to 61 being vertical, a strike slip fault regime corresponds to σ₂ being vertical and a thrust or reverse fault regime corresponds to σ₃ being vertical. The tectonic regime 300 may also define stresses σ_{H}, σₕ and σᵥ are the maximum horizontal stress (σ_{H}), a minimum horizontal stress (σₕ) that may be orthogonal to the maximum horizontal stress, and a vertical stress (σᵥ). The orientation of the maximum horizontal stress σ_{H} may be defined by an angle θ_{H}, which may be local (e.g., for a point or a feature), far field, etc.

As an example, various types of parameters may be germane to field activities such as drilling, well completion, seismic migration velocity model construction, wellbore stability, hydraulic fracturing design and hydraulic fracture monitoring. As an example, as to shale gas reservoirs, knowledge of anisotropy parameters can assist with planning, execution, etc., especially where one or more well configurations may vary over some range between vertical and horizontal.

As an example, information may be acquired about a formation using seismology, for example, to acquire seismic data. As mentioned, seismic data may be processed using a framework such as, for example, the PETREL® framework. As an example, such a framework may include one or more interfaces for receipt of seismic data, imagery data, etc. Such a framework may include one or more modules with instructions executable to process received data. As an example, seismic data may optionally be analyzed to determine one or more parameters.

As an example, flow of fluid into and/or out of a reservoir may be modeled and simulated using a reservoir simulator such as, for example, the ECLIPSE® reservoir simulator or the INTERSECT® reservoir simulator. As an example, geomechanics of a basin, a reservoir, etc. may be modeled and simulated using a framework such as, for example, the VISAGE® framework (Schlumberger Limited, Houston, Tex.). As an example, information may be coupled from simulators, frameworks, etc. For example, flow information from a reservoir simulator may be input to a geomechanics framework that can model response of a geologic environment to flow (e.g., injection flow and/or production flow).

As an example, a framework may include one or more modules that can model stimulation of a geologic environment, for example, to generate one or more fractures. For example, consider the commercially available MANGROVE® framework (Schlumberger Limited, Houston, Tex.), which may be operated in conjunction with one or more other frameworks. The MANGROVE® framework may be operated as a hydraulic fracturing simulator and may be, for example, integrated into one or more seismic-to-simulation workflows (e.g., for conventional and/or unconventional reservoirs) and/or one or more other types of workflows. As an example, the MANGROVE® package may be implemented to grid and model complex fractures, which may be used for reservoir simulation (e.g., via the ECLIPSE® framework, the INTERSECT® framework, etc.).

As an example, stimulation design functionality may be implemented to predict realistic fracture scenarios. As an example, an unconventional fracture model (UFM) may be utilized for simulation of one or more fractures. As an example, a UFM may be utilized to simulate fracture network propagation in a formation with pre-existing natural fractures. In such an example, simulation results may reveal generation and/or reactivation of multiple fracture branches where some of the fracture branches may intersect (e.g., forming a coupled fracture network).

As an example, stimulation modeling may be coupled with geomechanical modeling and/or reservoir modeling. As to geomechanics, as an example, an opening or open fracture (e.g., including fluid, proppant, etc.), can exert stresses on surrounding rock and, for example, one or more adjacent fractures (e.g., a “stress shadow” effect). As an example, fluid in reservoir rock may drain into a fracture, which may alter pressures in the reservoir rock, which may lead to some amount of compaction of the reservoir rock.

As an example, a stress shadow may act to restrict fracture width, which may increase risk of flow restriction (e.g., consider proppant screenout, etc.). As an example, a stress shadow may alter a fracture propagation path, which may affect a fracture network pattern.

As an example, a method may include reservoir modeling, stimulation modeling (e.g., fracture modeling) and geomechanical modeling, for example, to couple flows, fractures and stresses (e.g., as well as strains that may develop over time). As an example, a stimulation framework may be implemented as a part of a workflow that aims to optimize well completion designs. As an example, a stimulation framework may be implemented as part of a workflow that aims to assess well survivability (e.g., as may be affected by one or more fracturing operations, flow in fractures, etc.).

A stimulation design workflow may provide estimates of proppant placement, fracture network dimensions, and reservoir penetration based on formation properties such as, for example, one or more of reservoir fluid rheology, leakoff coefficient, permeability, and closure stress.

As an example, a feedback loop may be implemented to compare simulations to actual results. For example, real-time data, such as that acquired by a hydraulic fracture mapping service (e.g., consider STIMMAP® as a stimulation mapping service) may be compared to simulated results (e.g., to help to optimize treatments as they are being performed). Such comparisons may help improve well planning and reduce operational risks.

As an example, a workflow may include simulating wellbore stability conditions for drilling applications. Stability conditions may include, for example, one or more of mechanical stability and/or chemical stability conditions along a given well trajectory. As an example, stability conditions may concern rock, hydraulic fractures, natural fractures and faults, bedding surfaces, etc.

As an example, the MANGROVE® framework may provide for generation of suitable resolution simulation grids by gridding one or more fracture networks while capturing fracture dimensions and conductivities, as well as tracking the propped and unpropped regions in a network or networks. As an example, unstructured and/or structured gridding tools, as appropriate, may be implemented to help capture geology and fracture stimulation impact.

As an example, one or more of a planar fracture model, a multilayer fracture model, a UFM and a wiremesh model may be implemented for simulating fractures such as, for example, nonplanar complex hydraulic fractures in shale reservoirs and/or “conventional” planar fractures.

As an example, a UFM may be coupled to numerical modeling framework, for example, for simulating complex fracture geometries, while accounting for reservoir heterogeneity, stress anisotropy, and stress-shadow effects. Such an approach may model hydraulic fracture interactions with natural fractures while solving for fracture propagation mechanics and proppant transport. As to a wiremesh model, it may include a mathematical representation of a hydraulic fracture network, which may, for example, provide for estimation of proppant placement and fracture network dimensions.

As an example, hydraulic fracture simulator models may model fracture growth into layers above and/or below a pay zone, for example, along with bi-wing fracture extension. As an example, the MULTIFRAC™ package (Schlumberger Limited, Houston Tex.) may provide for simultaneous multizone fracturing simulations (e.g., with simultaneous initiation and extension of multiple hydraulic fractures).

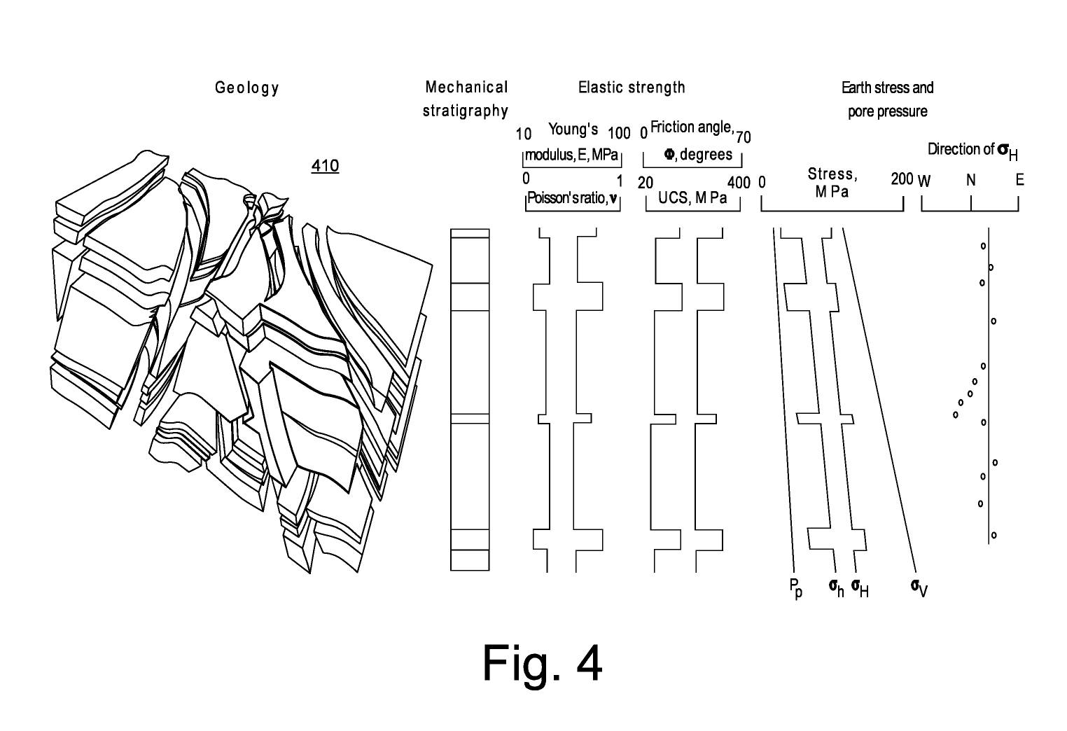

FIG. 4 shows an example of a model 410 of a geologic environment. As shown, the model 410 is stratified where various types of information exist for the strata. For example, FIG. 4 shows information about facies types and local deformation mechanisms from which profiles of elastic and rock-strength parameters such as, for example, unconfined compressive strength (UCS) may be determined. Such parameters may be used, for example, to estimate pore pressure, minimum and maximum horizontal stresses and vertical stress.

The model 410 of FIG. 4 may be a mechanical earth model (MEM) suitable for use in a geomechanics simulation workflow. For example, the model 410 may be an expanded view of a finite element model suitable for use in the VISAGE® framework for performing geomechanical simulations.

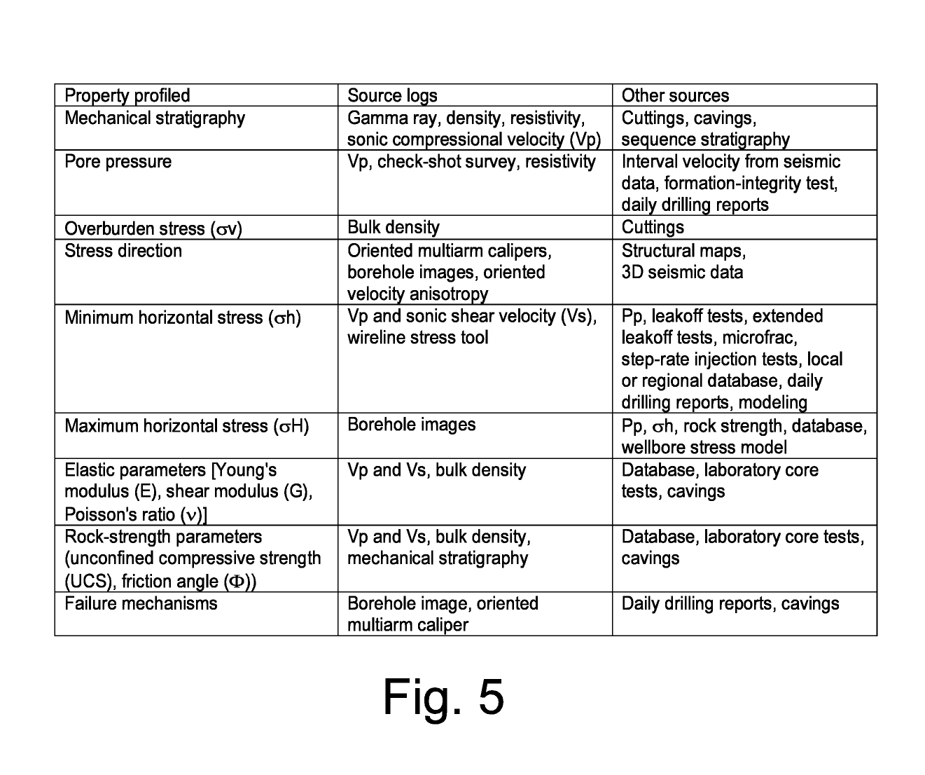

FIG. 5 shows information associated with properties. As shown, the information can include information from logs and/or information from one or more other sources. As an example, the data in FIG. 4 corresponding to the model 410 may be based at least in part on one or more types of information such as types of information shown in FIG. 5. As an example, at least a portion of the sources of FIG. 5 can be sources used to build a MEM.

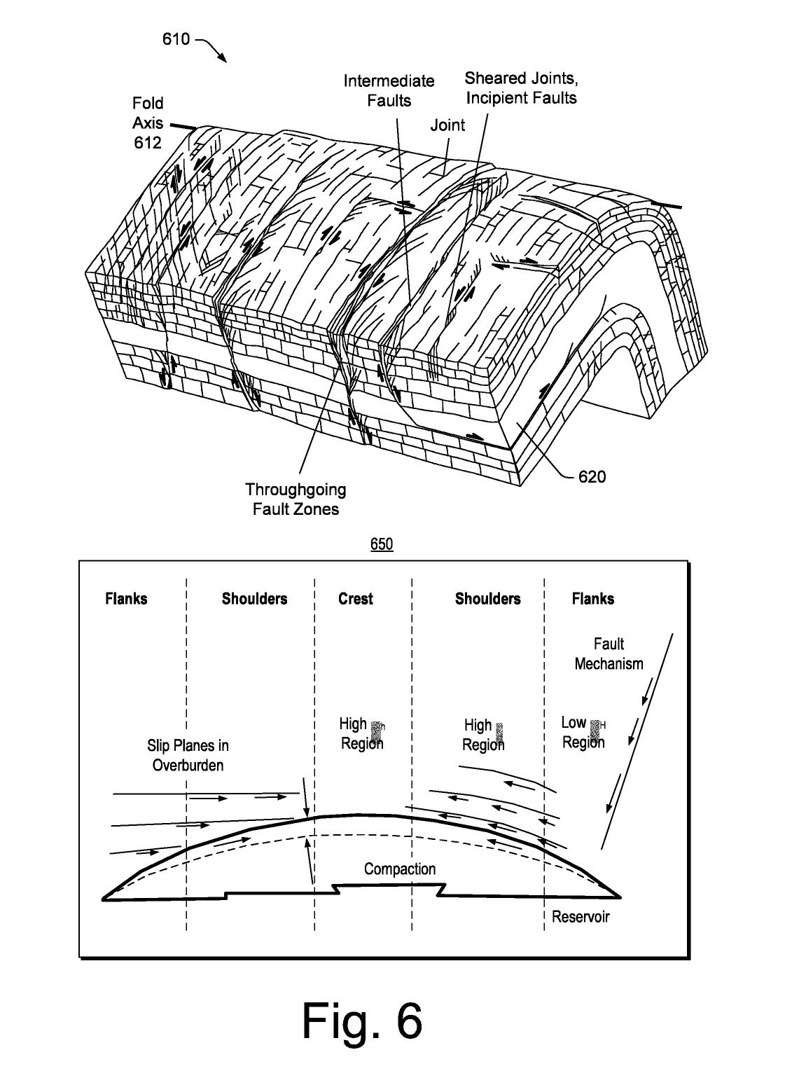

FIG. 6 shows an example of a geologic environment 610 that includes folds, faults and fractures along an anticline 620. In folded rocks, faults and fractures may be oriented, for example, parallel or perpendicular to a fold axis. Fractures may form in response to stress, joints may form by means of tensile stresses and faults may form by means of shear stresses. Deformation over time may cause fractures to extend and, for example, change direction of motion along fracture planes. Faults and fractures may be stratabound and, for example, confined to a single layer or they may be or become throughgoing where they may cross sedimentary sequences and span one or more formations within a geologic environment. Connectivity may range from isolated individual fractures to widely spaced fracture swarms or corridors, which may be interconnected fracture networks.

As to exploration and development, vertical and/or deviated wells (e.g., horizontal wells, etc.) may be drilled into an environment. For example, substantially horizontal wells may be drilled parallel to a fold axis 612 as illustrated in the geologic environment 610 to increase the well's ability to intersect fractures. As an example, a method may include analyzing stability and/or instability of one or more bores in an environment that may include one or more of the features of the geologic environment 610.

FIG. 6 illustrates various examples of forces (see, e.g., arrows) that may be present in a geologic environment. As an example, production and/or injection of a reservoir or reservoirs in such an environment may alter forces, particularly over time as production and/or injection may occur and/or after production and/or injection may have occurred.

In a geologic environment, pore pressure may change over time as well as porosity. As an example, a model may include a dual approach to porosity where a matrix value (e.g., a rock matrix) is assigned to a region or regions and where fractures, faults, etc. may be assigned more specific values (e.g., as discontinuities in a matrix, etc.). For example, a model may include one or more matrix regions and one or more discrete fracture networks. Deformation may affect porosity values, pore pressures, etc. As an example, factors such as temperature and circulation may also affect material characteristics and be intertwined with deformation. Permeability in a region may depend on one or more factors, for example, relationships may exist between porosity and permeability. As a field compacts, flexure of the compacting field can cause slippage along weak lithologies or discontinuities (e.g., unconformities, interfaces between formations, interfaces of faults, fractures, etc.).

Referring again to FIG. 6, the environment 650 illustrates how a portion of a field may compact. For example, flexure of a compacting field can cause slippage between weak lithologies or discontinuities. In such an example, on a field scale, total compaction and subsidence may be determined (e.g., analytically and/or numerically).

As an example, a method may be implemented via one or more frameworks such as, for example, the PETREL® framework, the OCEAN® framework, the VISAGE® framework, the INTERSECT® framework, the ECLIPSE® framework, the MANGROVE® framework, etc.

As an example, a geomechanics simulator may be configured to perform simulations based at least in part on finite elements, for example, via a finite element technique (e.g., a finite element method (FEM)). As an example, consider a geomechanics simulator such as the VISAGE® finite-element geomechanics simulator (e.g., of the VISAGE® framework). As an example, a method may be implemented via execution of instructions stored in memory (e.g., via one or more processors). As an example, instructions and a computing system may be considered to be a “simulator”. As an example, consider the VISAGE® simulator.

As an example, a geomechanics simulator may include modules for modeling compaction and subsidence; well and completion integrity; cap-rock and fault-seal integrity; fracture behavior; thermal recovery; CO₂ disposal; etc.

As an example, a seismic-to-simulation framework such as the PETREL® framework, optionally in combination with the OCEAN® framework, may include features that facilitate data flows and that provide graphical user interfaces that support geomechanics simulation, configuration and results visualization.

As an example, a workflow may include receiving information in one or more of multiple data types, for example, to create multidimensional geomechanics property and stress models, or add geomechanics data to augment existing reservoir subsurface models. Integration of seismic-to-simulation workflows capabilities with geomechanics workflow capabilities may aid in geomechanics model development, for example, to generate a model (e.g., via integration with one or more of geophysics, geology, petrophysics, and reservoir data).

As an example, a workflow may include creating an initial structural and properties model (e.g., using reservoir geomechanics), which may be input to a geomechanics numerical simulator. As an example, such a workflow may integrate PETREL® framework and VISAGE® geomechanics simulator functionalities, optionally in an OCEAN® framework.

As an example, a geomechanics simulator may be operatively coupled to a reservoir simulator. For example, the VISAGE® framework simulator may be operatively coupled to the ECLIPSE® framework reservoir simulator (e.g., for one-way and two-way coupling). For example, in one-way coupling, the ECLIPSE® framework simulator may model flow of fluids in a reservoir and calculate pressure, temperature, and saturation changes that result. In such an example, the VISAGE®framework simulator may use calculated results of the ECLIPSE® framework simulator to perform 3D static and/or 4D flow-, pressure-, and temperature-coupled calculations for rock stresses, deformations, and failure. As an example, two-way coupling between the ECLIPSE® framework and VISAGE® framework simulators may allow permeability and/or porosity updating of a reservoir model at one or more selected time-steps, as well as, for example, updating of mechanical properties in the geomechanics model to account for effects such as changing saturations, water softening, water weakening (e.g., as in chalk reservoirs), etc. As an example, a method can include updating permeability or updating permeability and porosity. As an example, deformation may impact porosity (e.g., compaction reducing porosity).

As an example, where a model may be large (e.g., millions of elements), or coupled to reservoir simulation, a computing system may be configured to perform parallel geomechanics simulation runs, for example, using local or remote clusters. As an example, a process (e.g., for single machines and/or multicore clusters) may be managed by a framework that can permit seamless workflows. As an example, a reservoir simulation may be run using at least in part parallel processing.

A geomechanics simulator may include one or more modules that can model faults, fractures, etc. As an example, one or more modules may provide for handling of highly heterogeneous models (e.g., where high-degree complexity that exists in a geological model may be maintained throughout a geomechanics analyses).

As an example, a geomechanics simulator may include one or more modules for 3D and 4D geomechanics simulation, for example, across one or more portions of a field's lifecycle. Such capabilities may allow geoscientists and engineers to assess and mitigate potential geomechanics problems affecting well and completions, stimulation, production, injection, and field management.

A PETREL® reservoir geomechanics package may be implemented, for example, as an integrated environment for multi-dimensional preproduction geomechanics modeling or for 4D geomechanics modeling of fields under operation. As an example, finite-element geomechanics simulation (e.g., via the VISAGE® framework simulator) may be combined with one or more other interpretation and modeling workflows (e.g., within a PETREL® framework).

As an example, a reservoir geomechanical model may include horizontal grid cell dimensions in a range of about 50 m to about 200 m, and, as an example, vertical grid cell dimensions may optionally be smaller, for example, of the order of a few meters to tens of meters. As an example, one or more single dimensional (e.g., 1D) geomechanical models may include log-scale resolution along a bore (e.g., a well, etc.) for a region proximate to the bore. As an example, a workflow may be constructed that can integrate functionality that may be available in a number of applications, for example, to consume 3D geomechanical input for drilling and completion analyses at well sector scale.

As an example, an approach may include implementation of a fracture design application such as the MANGROVE® framework, which may include one or more modules for unconventional fracture modeling (e.g., for hydraulic fracture design and evaluation).

Fluid production and injection can alter a pressure field in a reservoir and, in certain cases, a temperature field around producers and/or injectors. Such perturbations may affect the state of stress and lead to deformation, for example, in a reservoir and/or in the surrounding rocks.

As an example, a method may include assessing complexities associated with 3D structure (e.g., optionally faults, fractures, etc.) and, for example, heterogeneity in material properties and/or pressures distributions.

As an example, a seismic survey may be performed at one time and at another time. In such an example, data acquired from the seismic surveys may be used to assess deformation. As an example, deformation may occur at one or more time scales. For example, phenomena may operate to cause a fault to slip with a displacement with respect to time and other phenomena may operate to cause compaction with small displacement with respect to time.

As an example, a method can include acquiring data such as one or more of satellite data, GPS data, dipmeter data, radioactive marker data, intelligent marker data (e.g., RFID-based, etc.), etc. As an example, data may be acquired at one or more times, which may be considered time-lapse data. As an example, a seismic survey may be performed in a time-lapse manner. Such a survey may acquire multidimensional data where one of the dimensions is temporal (e.g., time). For example, consider 4D seismic data that includes three spatial dimensions and a time dimension.

As an example, geomechanics simulation data may include data that corresponds to a multidimensional gridded representation of a subsurface region where the grid may define grid cells with data. For example, consider strain tensor data associated with a plurality of grid cells. In such an example, individual grid cells may be associated with strain tensor data, in geographical coordinates, at one or more times. For example, consider a pre-production time associated with a pre-production state of a subsurface region that includes one or more reservoirs and one or more times associated with production states (e.g., one or more times after which an initial flow of fluid has commenced).

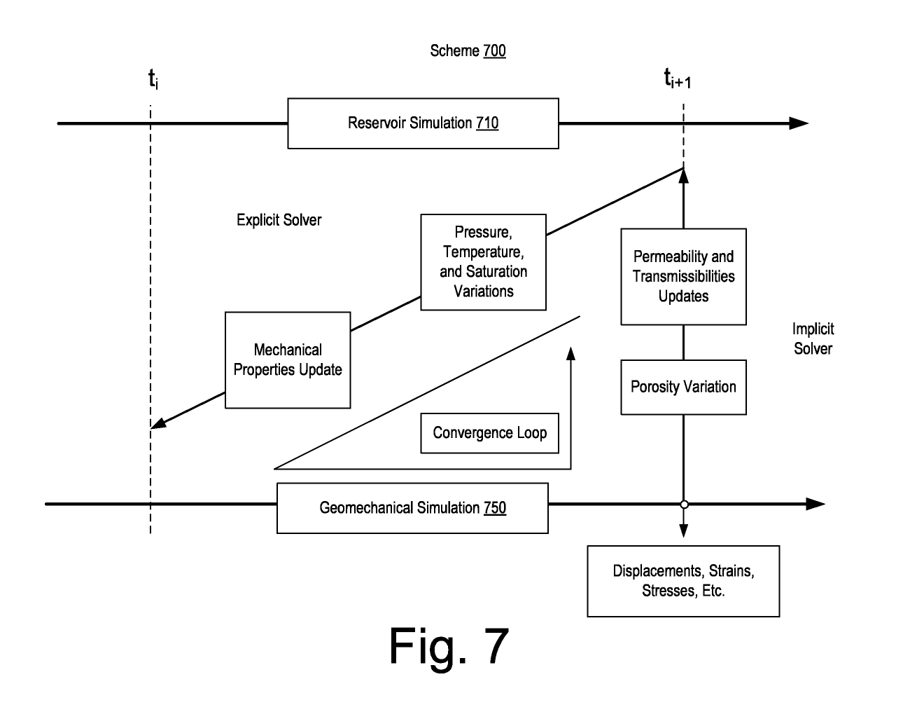

FIG. 7 shows an example of a scheme 700 that includes reservoir simulation 710 and geomechanical simulation 750. The scheme 700 provides for coupling of reservoir simulation 710 and geomechanical simulation 750 where a reservoir simulator can calculate changes in pressure, temperature and saturation over one time step and input results into a previous time step of a geomechanics simulator to update mechanical properties and reservoir permeability. The geomechanics simulator can calculate displacements, strains and changes in stress associated with changes in one or more of pressure, temperature and saturation. As an example, two-way coupling can update reservoir permeabilities and porosities.

In such staggered coupled simulations, a liaison can be established at selected time-steps between the geomechanics simulator and the reservoir simulator. The geomechanics simulator can solve for change in stress, strain, and displacements associated with changes in fluid pressures, temperatures, and/or saturations. The reservoir simulator can solve for change in fluid pressures, in temperatures, and/or in saturations associated with, for example, a prescribed production and/or injection schedule and with changes in porosities and/or in permeabilities. As an example, a coupling scheme can include one-way coupling and two-way coupling, depending on whether information is passed from a reservoir simulator to a geomechanics simulator, or if information is also passed from a geomechanics simulator back to a reservoir simulator. Former information may include fluid pressures, temperatures, and/or saturations, for example, either absolute or incremental relative to a previous time-step. As illustrated in FIG. 7, geomechanical model properties may be updated accordingly. For example, the Young's modulus may be updated following a change in fluid pressure, when the Young's modulus is expected to be sensitive to effective confining stress, or rock strength may be updated following a change in water saturations, when exposure to water is expected to weaken the rock. Information passed from a geomechanics simulator to a reservoir simulator may include changes in porosities and/or changes in both porosities and permeabilities (e.g., based at least in part on calculated strains).

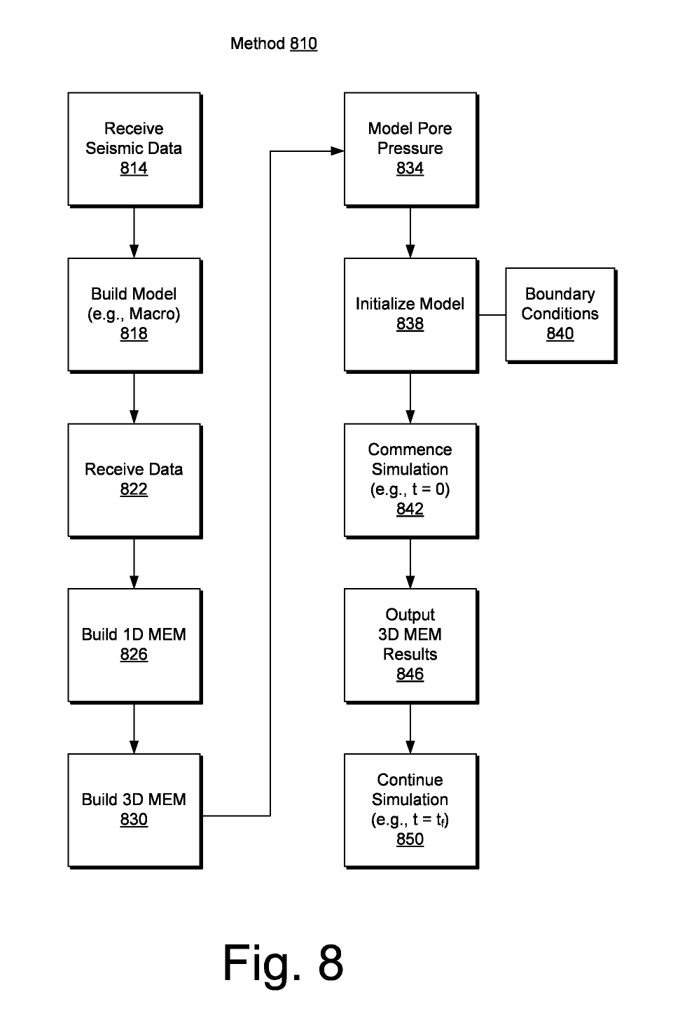

FIG. 8 shows an example of a method 810 associated with geomechanical simulation. As shown in the example of FIG. 8, the method 810 can include a reception block 814 for receiving seismic data, a build block 818 for building a model (e.g., a macro-scale model), a reception block 1022 for receiving borehole data, a build block 826 for building one or more 1D mechanical earth models (MEMs) based at least in part on at least a portion of the borehole data (e.g., for one or more boreholes), a build block 830 for building a 3D MEM, a model block 834 for modeling pore pressure within the 3D MEM, an initialization block 838 for initializing the 3D MEM, a commencement block 842 for commencing geomechanical simulation, an output block 846 for outputting results of the geomechanical simulation for at least a portion of the 3D MEM and a continuation block 850 for continuing to simulate behavior, for example, for one or more future times.

As an example, the method 810 can include implementing a geomechanics simulator such as that of the VISAGE® framework. As an example, the method 810 may include implementing one or more seismic analysis features such as one or more of those of the PETREL® framework. As an example, borehole data may be available through a scanner tool (e.g., a sonic scanning too), a pressure measurement tool, a dynamic formation probe tool, an imager tool, etc.

As an example, a model can include a multidimensional grid that represents a geologic environment. In such an example, the model can include a region of interest, for example, consider a reservoir or a portion of a reservoir as a region of interest in a geologic environment. As an example, a model may extend in one or more dimensions beyond a region of interest. For example, consider a region of interest that is represented by a grid that includes a bottom side or bottom face, a top side or top face and lateral sides. In such an example, a model may be formed by extending the grid by adding one or more “side burdens” to corresponding one or more lateral sides. As an example, an underburden may be added adjacent to a bottom side or bottom face of a model. As an example, an overburden adjacent to a top side or top face may be due to rock and/or water (e.g., a subsea surface). A method can include adding burdens to alter an aspect ratio of a model, to address transfer of stresses to a region of interest from a burden or burdens, etc.

As to the initiation block 838, as shown, it may receive information from a boundary condition block 840. As an example, boundary conditions may be of one or more types. For example, consider stress type boundary conditions (e.g., stress boundary conditions) and consider displacement type boundary conditions.

As an example, a method can include initializing a model by imposing boundary conditions and solving a system of equations associated with the model where the model is subjected to gravity loading. As mentioned, a model can include a bottom side or bottom face, a top side or top face and lateral sides. In such an example, boundary conditions can be applied to the lateral sides such that at least one or more portions of at least one lateral side may be displaced. As an example, lateral sides may be relatively “free” to move in a direction aligned with Earth's gravity while, for example, being constrained according to one or more boundary conditions laterally, which may specify an amount of displacement and/or otherwise affect how displacement may occur, if allowed to occur. As an example, a bottom side or bottom face may be subject to one or more fixed conditions such that the bottom face is not displaced, for example, in a direction aligned with Earth's gravity (e.g., depth). As an example, a top side or top face may be a free surface that can be displaced in at least a direction aligned with Earth's gravity (e.g., depth). As an example, a model may be subjected to gravity (e.g., Earth's gravity) such that the model experiences various forces that can cause changes to the model such as compaction. As an example, a model may be subjected to gravity and pore pressure such that the model experiences forces that can cause changes to the model.

As an example, a method can include performing stress initialization for a model. Stress initialization can include solving for distribution of stress as to a state that complies with equilibrium equations and prescribed boundary conditions. As mentioned, such a model can include a bottom side or bottom face, a top side or top face and lateral sides. Stress initialization can include performing gravity loading to determine an initial distribution of stress in the model (e.g., vertical stress) and reaction forces acting on the model's lateral sides and bottom side or bottom face. As an example, various forces may be subtracted and other forces applied to load the model for simulation. As an example, side force magnitudes may be adjusted until a base case model minimum horizontal stress is in substantial agreement with other stress information (e.g., 1D mechanical earth model (MEM), etc.).

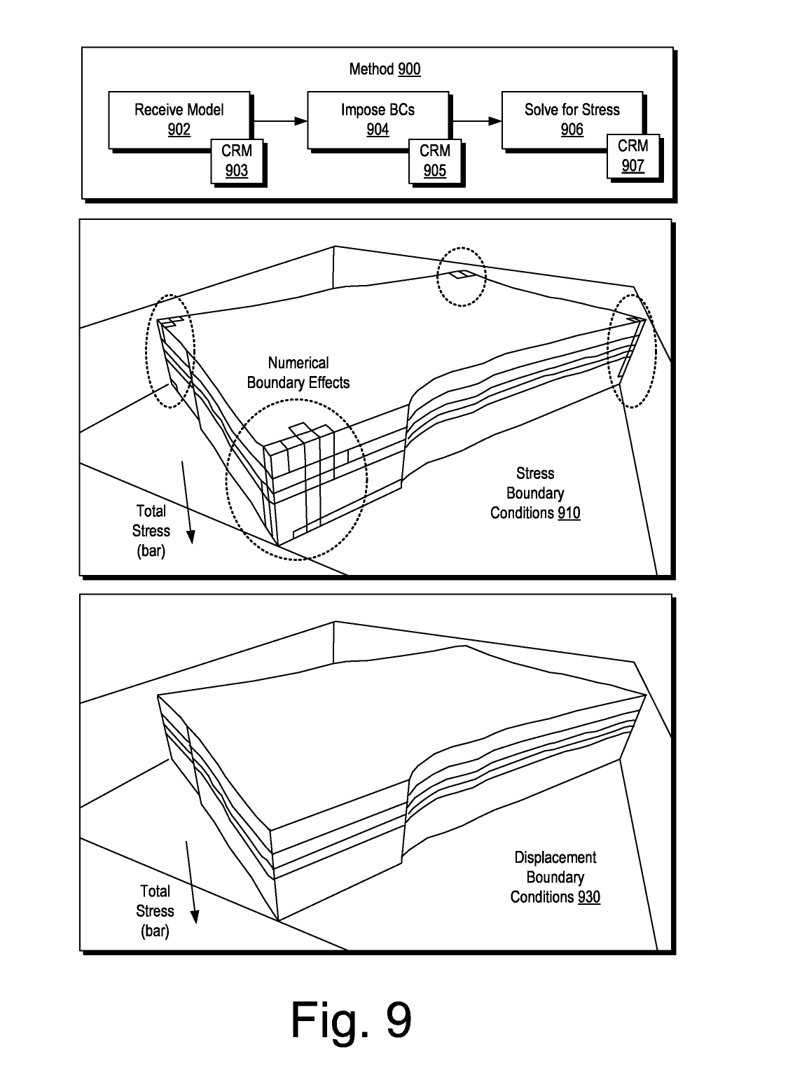

FIG. 9 shows an example of a method 900, an example of a plot 910 of a model of a geologic environment with respect to total stress data for a simulation with stress boundary conditions and an example of a plot 930 of the model of the geologic environment with respect to total stress data for a simulation with displacement boundary conditions.

The method 900 includes a reception block 902 for receiving a model of a geologic environment; an imposition block 904 for imposing displacement boundary conditions on at least one boundary of the model; and a solution block 906 for solving for equilibrium stress for the model subject to the displacement boundary conditions.

In the example of FIG. 9, the method 900 is shown along with computer-readable media blocks 903, 905 and 907. Such blocks can include processor-executable instructions stored in a computer-readable storage medium that is not a carrier wave. As an example, a system such as, for example, the system 250 of FIG. 2, may be suitable for implementation of at least a portion of the method 900. As an example, the blocks 903, 905 and 907 may be one or more modules such as, for example, one or more of the modules 270 of the system 250 of FIG. 2.

As shown, the plot 910 for the simulation with the stress boundary conditions includes numerical effects at the corners of the model; whereas, the plot 930 does not include such numerical effects. Further, the simulation corresponding to the plot 910 has a longer simulation time than the simulation corresponding to the plot 930. As mentioned, while side burdens may be added adjacent to a region of interest to extend a grid of a model (e.g., to address transfer of stresses to a region of interest from a burden or burdens), such an approach increases the size of the model and, as shown in the plot 910, for stress boundary conditions, can still result in numerical effects.

As an example, a simulator can include an option to implement reservoir geomechanics boundary conditions that are specified at least in part according to displacement, which may be input as strain information. As an example, a framework such as the OCEAN® framework can include a plugin module for implementation of displacement boundary conditions (e.g., based on input of strain information, etc.). Such a plugin may be, for example, a plugin for the PETREL® seismic-to-simulation framework operating in conjunction with the OCEAN® framework. As an example, such boundary conditions may be specified to initialize a simulation model (e.g., strain-based displacement boundary conditions for stress initialization).

As an example, a module may provide for displacement boundary conditions for purposes of 3D and/or 4D reservoir geomechanical modeling. In such an example, the modeling may be for one or more of drilling, completion, production, etc.

As an example, a simulation may be performed for a model initialized with displacement boundary conditions that solves for an initial stress field. As an example, a method can include performing an initialization for side boundary conditions (BCs) set in terms of displacement.

As an example, a method can include solving for displacements (e.g., strains) that, when applied, will deform a model shape according to a given strain field. Such an approach can allow a user to set boundary conditions based on an understanding of the strain field.

As an example, a displacement boundary conditions module can allow for stress initialization using displacement boundary conditions on, for example, at least a portion of one or more lateral faces of a model. For example, as part of an initialization process, a method can take, as inputs, a grid and principal horizontal strains (e.g., as provided from another program, a user via a graphical user interface, etc.).

As an example, a method can include solving for the displacements at one or more nodes of one or more lateral faces that, when applied, will deform the grid shape according to the prescribed strain field.

As an example, a displacement BC module can allow for input of the desired boundary conditions as horizontal strains. Such an approach may be applied to a 3D or a 4D simulation in a manner akin to the way displacement boundary conditions may be passed to a 1D stress model.

As an example, a displacement BC module can be executed for generation of a file that includes horizontal displacements at nodes located on lateral faces, which may also track input parameters.

As an example, implementation of displacement BCs in a simulation can result in a reduction in side effects when compared to stress BCs (see, e.g., the plots 910 and 930 of FIG. 9), which can allow for reducing dimensions of side-burdens and, thus, that of the under-burden (e.g., insofar as embedment is meant to mitigate side effects).

As an example, implementation of displacement BCs can allow for faster, less memory-demanding and less storage execution of a simulation, for example, due to one or more of a reduction in model size, a better constrained problem, and a single call to VISAGE®, rather than multiple calls (e.g., two calls, etc.).

As an example, a method can include transferring from 1D to 3D MEMs' stress models, for example, where 1D stress modeling is performed using displacement BCs.

As an example, displacement BCs may be applied where the principal strain directions are aligned with Cartesian axes; otherwise involving back and forth grid rotations.

As an example, a method can take, as input, a strain field and an object, and solve for the displacements at the surface of the object that, when applied, will deform the object's shape according to the prescribed strain field.

As an example, a horizontal strain field (e.g., the “tectonic” component of the strain field) can be utilized where an object is a geocellular (geomechanical) model. As an example, displacements corresponding to the horizontal strain field, at the nodes located on the lateral faces of the geocellular model, can be solved using a method. Strain field information can then be prescribed as boundary conditions, and a finite element program can be called to solve for the stress field that honors the prescribed boundary conditions.

Referring to the boundary conditions block 840 of FIG. 8, a method can include solving for displacement values to be applied as boundary conditions. For example, information associated with a 1D MEM may be utilized to solve for strain information, which may be utilized to determine displacement values. Referring to FIG. 4, 1D values are shown for stress (σₕ, σ_{H} and σ_{V}) as well as direction of stress (direction or azimuth of σ_{H}). As an example, values may be provided for 1D strain (e.g., εₕ, ε_{H}) as well as direction of strain for the minimum strain component (e.g., azimuth of εₕ).

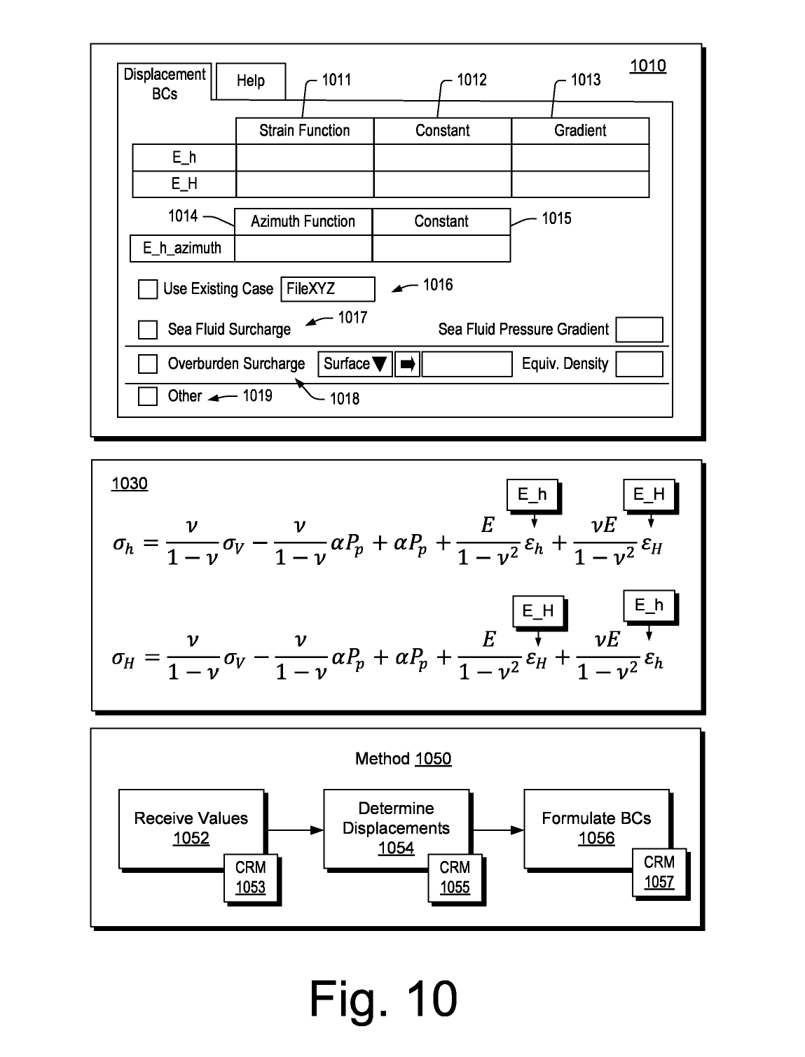

FIG. 10 shows an example of a graphical user interface 1010 that includes fields for displacement boundary condition values, including strains and an azimuth value. Specifically, the example GUI 1010 includes a strain function field 1011 for specifying strain as a function (e.g., consider a function of depth), a constant field 1012 for specifying strain as a constant, a gradient field 1013 for specifying strain as a gradient, an azimuth function field 1014 for specifying azimuth as a function and an azimuth constant field 1015 for specifying azimuth as a constant.

As an example, to calculate boundary inputs to be applied, as an example, a user may enter one or more horizontal principal stress magnitudes and/or azimuths calibration points (e.g., consider in the form of PETREL® framework properties, etc.). Such values, together with model dimensions and average elastic material properties, can be used to estimate regional strains at the boundary of a model.

In the example of FIG. 10, the GUI 1010 can include a feature 1016 to select an existing case (e.g., file, etc.). As shown in the example of FIG. 10, the GUI 1010 can include one or more surcharge options, which may be utilized as to one or more overburden conditions. For example, the GUI 1010 can include a sea fluid surcharge option 1017 where a sea fluid pressure gradient may be specified and, for example, the GUI 1010 can include an overburden surcharge option 1018 where a graphical control may be provided that allows for selection of a surface and where a field may provide for entry of an equivalent density. As an example, one or more other options may be available via a graphical control 1019.

FIG. 10 also shows examples of equations 1030, which are reproduced below:

$${σ}_{h} = \frac{v}{1 - v} {σ}_{V} - \frac{v}{1 - v} α {P}_{p} + α {P}_{p} + \frac{E}{1 - {v}^{2}} {ɛ}_{h} + \frac{vE}{1 - {v}^{2}} {ɛ}_{H}$$

$${σ}_{H} = \frac{v}{1 - v} {σ}_{V} - \frac{v}{1 - v} α {P}_{p} + α {P}_{p} + \frac{E}{1 - {v}^{2}} {ɛ}_{H} + \frac{vE}{1 - {v}^{2}} {ɛ}_{h}$$

where σₕ is the minimum horizontal stress, σ_{H} is the maximum horizontal stress, v is Poisson's ratio, α is Biot's constant, Pₚ is the reservoir fluid pressure or pore pressure and E is Young's modulus.

As an example, a geologic environment can include material that may be considered to be transversely isotropic. For example, there can be a particular directional character of material in which properties values may be estimated to be substantially the same in directions parallel to planes of isotropy and where different values exist perpendicular to or crossing the planes of isotropy (e.g., consider a perpendicular direction as an axis of rotational symmetry). As an example, equations that pertain to transverse isotropy may be utilized (e.g., for stresses, etc.).

The foregoing equations show relationships for stress and strain. The foregoing equations may be referred to as a poro-elastic horizontal strain model, which may be utilized for horizontal stress calculations in a 1D MEM (e.g., per the TECHLOG™ platform (Schlumberger Limited, Houston, Tex.), etc.).

As an example, various values for the foregoing relationships may be determined, for example, as explained with respect to FIGS. 4 and 5, above. For example, FIG. 4 shows values for Young's modulus, Poisson's ration, stress, etc.

Referring again to FIG. 10, an example of a method 1050 is shown that includes a reception block 1052 for receiving values; a determination block 1054 for determining displacements based at least in part on the received values; and a formulation block 1056 for formulating boundary conditions based at least in part on at least a portion of the determined displacements. For example, the values may be received via a GUI (see, e.g., the GUI 1010) and/or via another source. As an example, displacements may be determined for a model, for example, for boundary nodes of a geocelluar model of a geologic environment. As an example, the displacements may be utilized to formulate boundary conditions that can be imposed on a system of equations that reference the model (e.g., in a spatial coordinate system). As an example, the method 1050 of FIG. 10 may be implemented as part of a workflow with, for example, the method 900 of FIG. 9.

In the example of FIG. 10, the method 1050 is shown along with computer-readable media blocks 1053, 1055 and 1057. Such blocks can include processor-executable instructions stored in a computer-readable storage medium that is not a carrier wave. As an example, a system such as, for example, the system 250 of FIG. 2, may be suitable for implementation of at least a portion of the method 1050. As an example, the blocks 1053, 1055 and 1057 may be one or more modules such as, for example, one or more of the modules 270 of the system 250 of FIG. 2.

As an example, a solution to a mechanical problem can be specified to honor certain conditions. Such conditions may include conditions set on the outer surface of an object under consideration (e.g., boundary conditions).

As an example, a 2D or a 3D spatial geomechanical model may be a geocellular model that can include a bottom side, a top side, and lateral sides. For example, a 3D model can include a bottom side, a top side and four lateral sides for a total of size sides. As an example, conditions on the lateral sides may be set by prescribing stress conditions or displacement conditions. A method can include setting of side boundary conditions in displacement. As an example, a method can include determining what displacements to prescribe such that the shape of a geomechanical model is deformed according to a given (e.g., user-defined, computer generated, etc.) horizontal strain field.

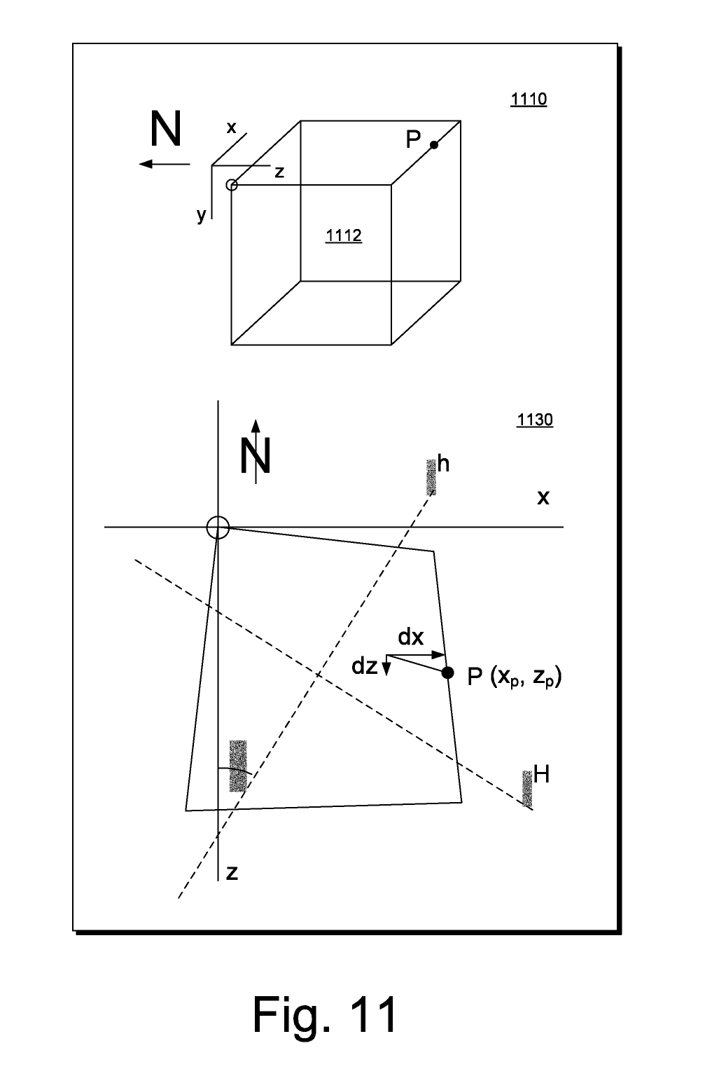

FIG. 11 shows a plot 1110 and a plot 1130 with respect to a Cartesian coordinate system x, y and z where y is in a depth direction and where North is along the z direction. In the example of FIG. 11, the plot 1110 illustrates a geocellular model 1112 (individual grid cells not illustrated) where the geocellular model 1112 includes four lateral sides, a bottom side or bottom face and a top side or top face.

A top or plan view of an outer boundary of the geocellular model 1112 is shown in the plot 1130 with a point P located on the boundary, with coordinates (xₚ, zₚ). In the example of FIG. 11, a reference point is selected as being one of the corners of the geocellular model 1112 (e.g., a top corner that is at the origin of the x and z axes).

As an example, a reference point may be selected to be in a model, on a model, outside of a model, etc. A reference point may be utilized in part to describe displacement.

In the plot 1130 a horizontal strain field is indicated by dashed lines, with the minimum and maximum principal horizontal strains denoted Eh and EH, respectively. The azimuth of the minimum principal horizontal strain direction is noted 0, reckoned positive clockwise East of North. As mentioned, strains can be received as input to determine displacement boundary conditions for a system of equations that are described with respect to a model such as the geocellular model 1112 of FIG. 11.

In the example of FIG. 11, the horizontal displacement, with components dx along x and dz along z, of a point with coordinate (x, z) can be calculated as follows:

dₓ=Cₐₐ*x+C_{ab}*z

d_{z}=C_{ab}*x+C_{bb}*z

where:

Cₐₐ=εₕ*sin²(θ)+ε_{H}*cos²(θ)

C_{ab}=(ε_{H}−εₕ)*cos(θ)*sin(θ)

C_{bb}=εₕ*cos²(θ)+ε_{H}*sin²(θ)

The above derivation can be performed for selected points (e.g., nodes of a model) located on, for example, lateral sides of a geocellular model. The resulting displacements at the side nodes can then imposed as boundary conditions to solve for the distribution of rock stress within the geocelluar model (see, e.g., the plots 910 and 930 of FIG. 9; where the plot 930 corresponds to values derived using displacement boundary conditions).

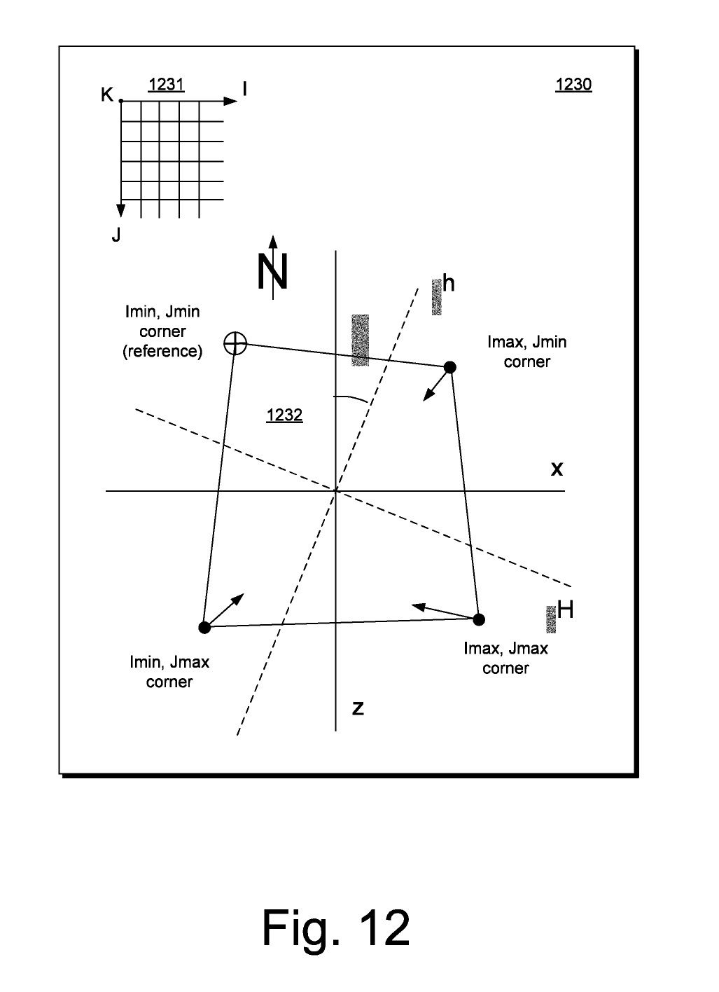

FIG. 12 shows an example of applying displacement boundary conditions 1230 with respect to an I, J coordinate system 1231 for a model 1232. As shown, one corner is fixed, which is specified to be the Imin, Jmin corner; whereas, displacements are specified at the other three corners with respect to the fixed corner as a reference point. Such displacement may be values determined via strain inputs (see, e.g., FIG. 10). For example, strain information may be input, received, etc. and displacement values determined with respect to a reference point in a model coordinate system where such displacement values may be applied as boundary conditions.

The approach shown in the example of FIG. 12 may be referred to as a four corner point displacement loading technique. Such displacements can be considered to be horizontal displacements. As an example, a method can include interpolating and assigning displacements at other locations. For example, consider a method that interpolates values for displacements based at least in part on one corner displacement value and a reference point.

In the example of FIG. 12, the I, J coordinate system 1231 can include a K coordinate that is substantially aligned with a direction of Earth's gravity. As an example, a K-face may be defined as a top face and a K-face may be defined as a bottom face. As an example, a top face may be subject to a condition such as a pressure or surcharge condition (see, e.g., the GUI 1010 of FIG. 10). As an example, the model 1232 may be subject to a vertical pressure gradient. As an example, a top face can be “free” at least in part in a K direction of an I, J, K coordinate system (e.g., index system of a grid). As an example, a bottom face can be fixed at least in part in a K direction of an I, J, K coordinate system (e.g., index system of a grid).

As an example, a method can include referencing a single point as a reference point where various boundary nodes of a model are referenced to that single point. As an example, a grid (e.g., or mesh) can be structured or unstructured. As an example, a grid may be indexed or not indexed (e.g., with respect to an I, J, K coordinate system, etc.). As an example, a grid may include one or more regions of local refinement. As an example, an unstructured grid can include one or more regions of local refinement.

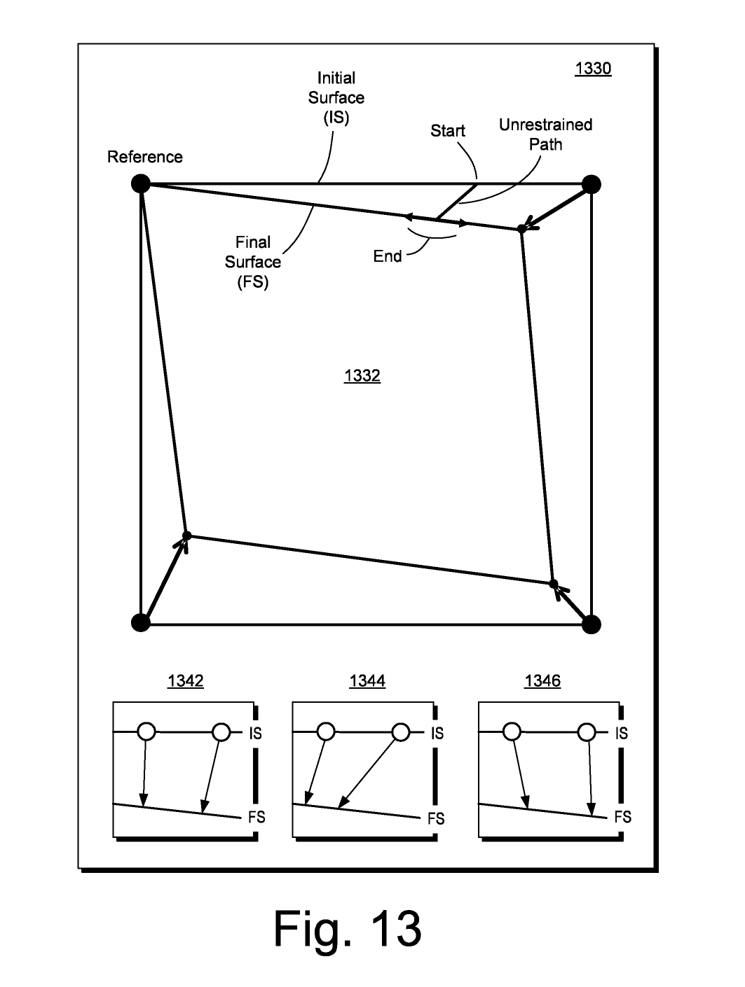

FIG. 13 shows an example of applying displacement boundary conditions 1330 to a model 1332. In the example of FIG. 13, one corner is fixed and displacements are provided for the other three corners. As shown, displacements of the three corners can define lines that represent sides in the two-dimensional view (e.g., a top view or a plan view of the model 1332). These lines can be end positions for the sides where nodes that define a side end up along a corresponding line. As an example, nodes may be relatively evenly spaced along a side, however, in the deformed state, these nodes may move (e.g., be displaced) in a manner such that they are no longer even, yet remain in a line (e.g., the specified line).

FIG. 13 also shows approximated example scenarios 1342, 1344 and 1346 where two nodes, which are not fully prescribed as to lateral displacement, are allowed freedom to move from the initial surface IS to the final surface FS. In the example scenario 1342, the nodes move respective distances at respective angles from the initial surface IS to the final surface FS; whereas, in the example scenarios 1344 and 1346, the distances and angles differ. However, in the example scenarios 1342, 1344 and 1346, the two nodes still end up on the same prescribed line (e.g., which may be a portion of a surface).

As an example, a method can include imposing incremental displacements. For example, in the approach of FIG. 13, the corner nodes may be displacement a first amount, a solution found, displaced a second amount, a solution found and then displaced a third amount. In such an example, the increments may number from about 2 to about 20 or more. Such an approach may allow other nodes to move incrementally as well, for example, the final surface FS in the example of FIG. 13 may be a imposed incrementally, for example, based on incremental displacement of the upper right corner node with respect to the upper left corner node (e.g., in the plan view of FIG. 13). While straight lines are illustrated in the example scenarios 1342, 1344 and 1346, paths may be incremented and change direction (e.g., angle) and amount of displacement (e.g., distance) on an increment-by-increment basis.

As an example, a method can include calculating constraints where, for example, rather than prescribing particular dx and dz displacements at various boundary nodes, a boundary is prescribed to move on a surface given by the displacements of corner nodes; noting that a corner node may serve as a fixed reference where other corner nodes may be displaced (see, e.g., the example of FIG. 13). In such an example, displacement boundary conditions can act to constrain individual nodes such that they remain on the surface prescribed by the displacements of at least some of the corner nodes (e.g., of a three-dimensional spatial model). In such a method, as explained with respect to the example of FIG. 13, nodes at the four vertical edges of the model 1332 (e.g., excepting a corner node as a reference point) can be given fully prescribed displacements (e.g., x and z), for example, as in the example of FIG. 12 where other nodes (e.g., intermediate nodes between pairs of corners), may be moved where they “want” onto a “final” surface.

As an example, an approach such as that of FIG. 13 can provide for at least some freedom of movement (e.g., displacement) as to nodes. Such an approach allows for at least some nodes to move relatively independently (e.g., be displaced), for example, due to varying material properties within a model. As an example, nodes on a lateral side can end up on a prescribed surface where, for example, corner nodes may be fully prescribed as to their lateral displacement (e.g., horizontal displacement). As an example, nodes that are between two corner nodes can move onto a surface constrained by boundary conditions. To reach the surface, the actual displacement can depend, for example, on properties assigned to cells, etc. For example, a node may move along a shortest line to the surface (e.g., a shortest distance) or may move a longer distance.

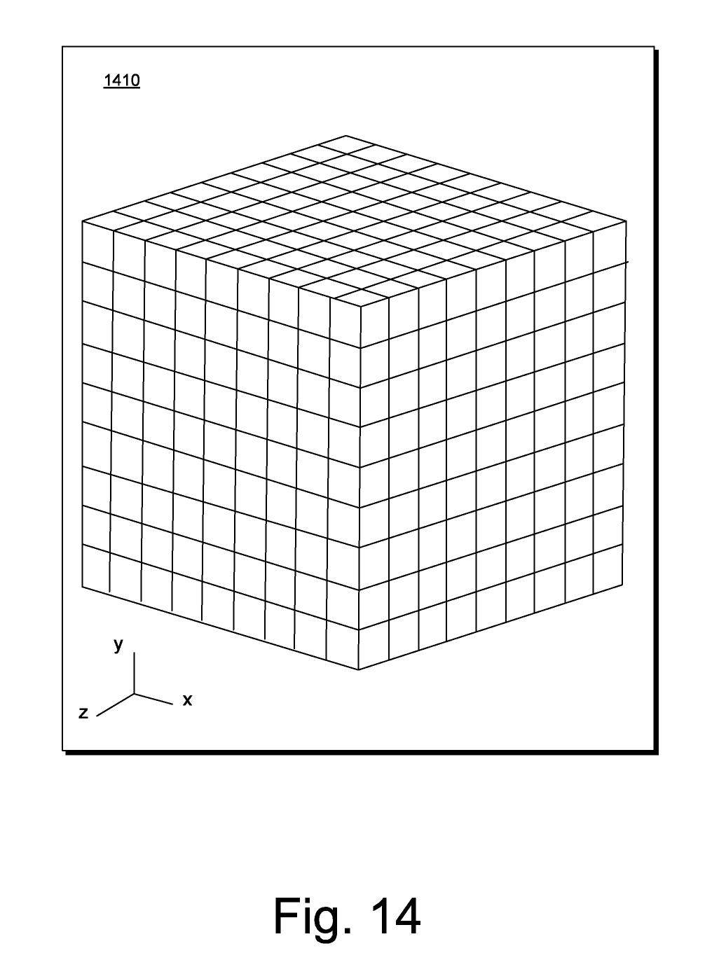

FIG. 14 shows an example of a geocellular model 1410, which can be, for example, a X×Y×Z cube, meshed regularly in directions x, y and z. As an example, mechanical properties (e.g., density, Young's modulus, and Poisson's ratio) can be assigned to cells of the model 1410 as uniform values.

As an example, the principal horizontal strains passed as input for the model can be as follows (e.g., where compression is reckoned negative):

εₕ=−1×10⁻⁴

ε_{H}=−5×10⁻⁴

θ=N 110° E

As an example, such values may be generated via an algorithm, accessed via memory, input via a graphical user interface, etc. As to a graphical user interface (GUI), consider the GUI 1010 of FIG. 10 where fields exist for input of values. As mentioned, a function or functions may be specified with respect to strain and/or azimuth. As an example, a function may be defined with respect to depth (e.g., total vertical depth, TVD). As an example, a gradient or gradients may be defined as to strain and/or azimuth. As an example, where a function is provided along with one or more other inputs, a method may default to the function. As an example, where a gradient is provided with a displacement value and without a function, a method may default to use of the gradient.

As an example, displacements of lateral nodes of a model can be computed as explained above. These can then be used to constrain a finite element problem for a geocellular model that may be solved via a finite element solver such as, for example, the VISAGE® framework simulator.

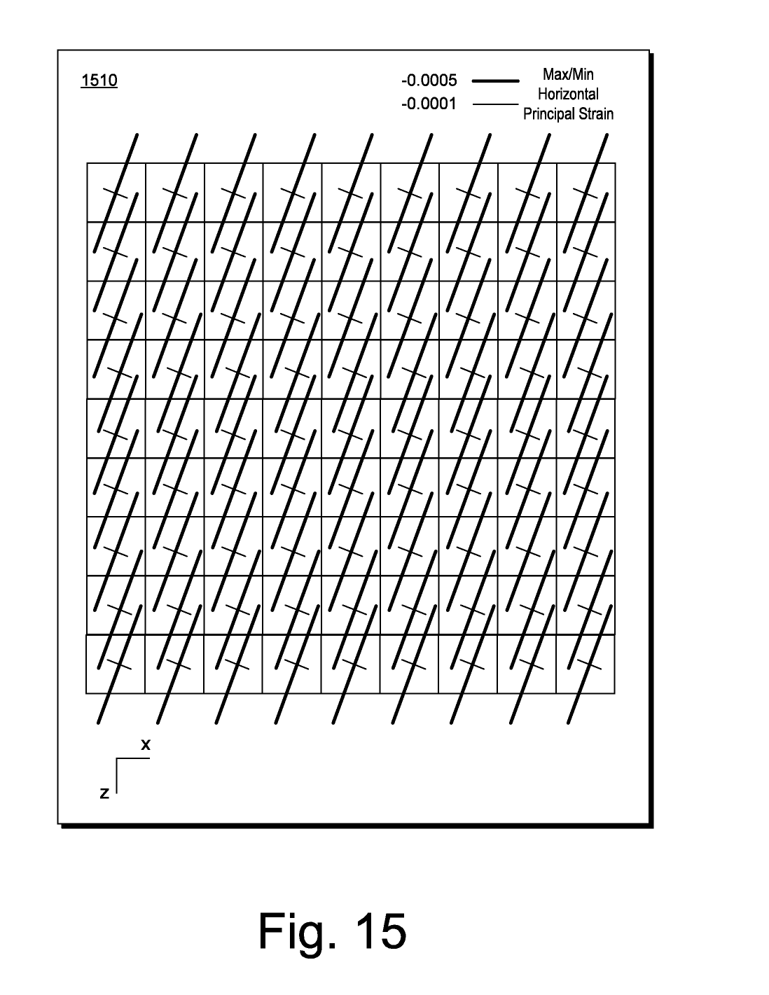

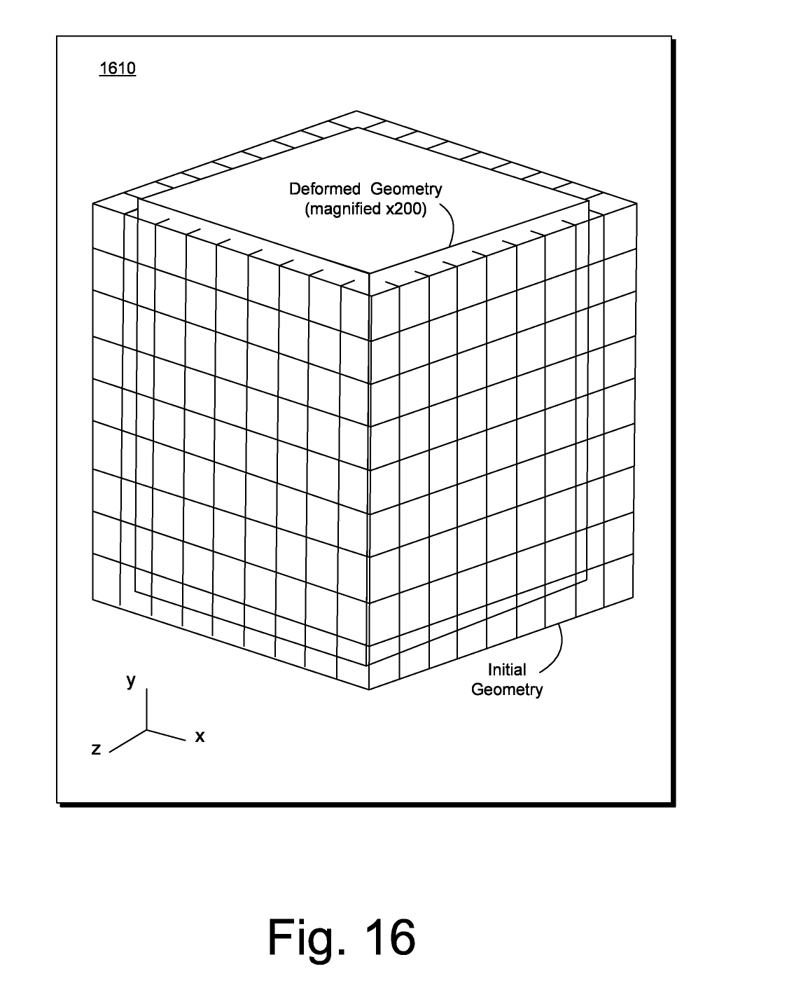

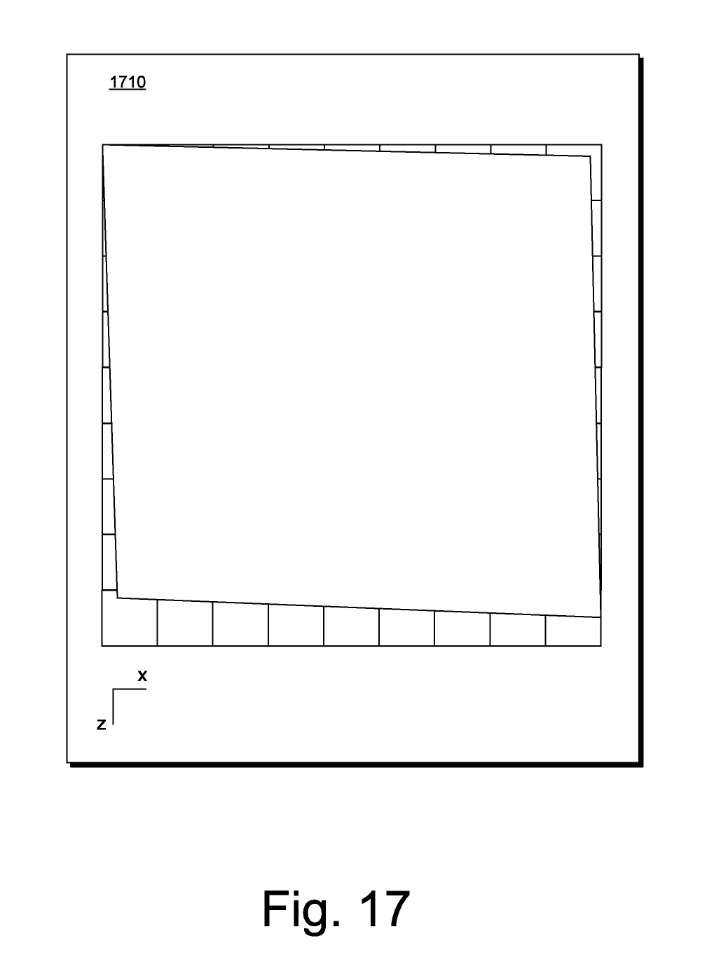

FIG. 15 shows a plot 1510 of a resulting strain field from within the geocellular model. FIGS. 16 and 17 show plots 1610 and 1710 that are views of the initial and deformed shapes. In FIGS. 16 and 17, it can be seen that that desired strain field is effectively reproduced, both in terms of orientation and magnitudes.

In FIG. 15, the plot 1510 shows a map view of the principal horizontal strains where lines indicate the principal directions and are thickness-coded according to the strain magnitude (e.g., thicker being about −0.0005 and thinner being about −0.0001).

In FIG. 16, the plot 1610 shows a perspective view of the original (meshed) and deformed (solid-filled) shapes of the model. As illustrated, the deformed model is displaced from the mesh. The plot 1610 also shows displacement values (e.g., in meters) as associated with the deformation of the model.

In FIG. 17, the plot 1710 is a map view of the original (meshed) and deformed (solid-filled) shapes of the model as in FIG. 16. The plot 1710 shows deformation in the x and z directions.

As an example, a method can include rendering a graphical user interface (GUI) to a display. For example, consider the GUI 1010 of FIG. 10. In such an example, a user can enter magnitude of the minimum and maximum principal horizontal strain components (E_h and E_H, respectively) together with the orientation of the minimum horizontal principal strain direction (E_h azimuth). As an example, an application may automatically recognize a grid as being the grid from which the application is launched. As an example, a user may point to a geomechanical simulation case, which then is modified to reflect the generated boundary conditions.

Referring again to the plots 910 and 930 of FIG. 9, compared to stress boundary conditions, displacement boundary conditions can reduce side effects, which can allow for reducing dimensions of side burdens (e.g., as may be added to keep side effects associated with a stress boundary condition approach relatively negligible over an area of interest). In such an example, a simulation may be performed using a model with reduced dimension or dimensions (e.g., a fewer number of cells). As an example, a displacement boundary condition approach can allow for reducing the dimension of the underburden (most of which is added in a stress boundary condition approach to prevent the bending of the model after the side-burdens have been added). As an example, a displacement boundary condition approach may allow for a reduction in model size of the order of about a 40 percent reduction when compared to a stress boundary condition approach.

As an example, a method that implements displacement boundary conditions may be faster and/or less memory-demanding as to execution, due to one or more of a reduction in model size, a better constrained problem (e.g., fewer degrees of freedom), and a single call to an finite element simulator (e.g., the VISAGE® simulator) instead of two (see, e.g., FIG. 7). Such an approach can provide for executing a simulator on a smaller computing platform (e.g., desktop, laptop, etc.).

As an example, a method can include transferring from 1D to 3D geomechanical models whenever 1D stress modeling is performed using displacement BCs.

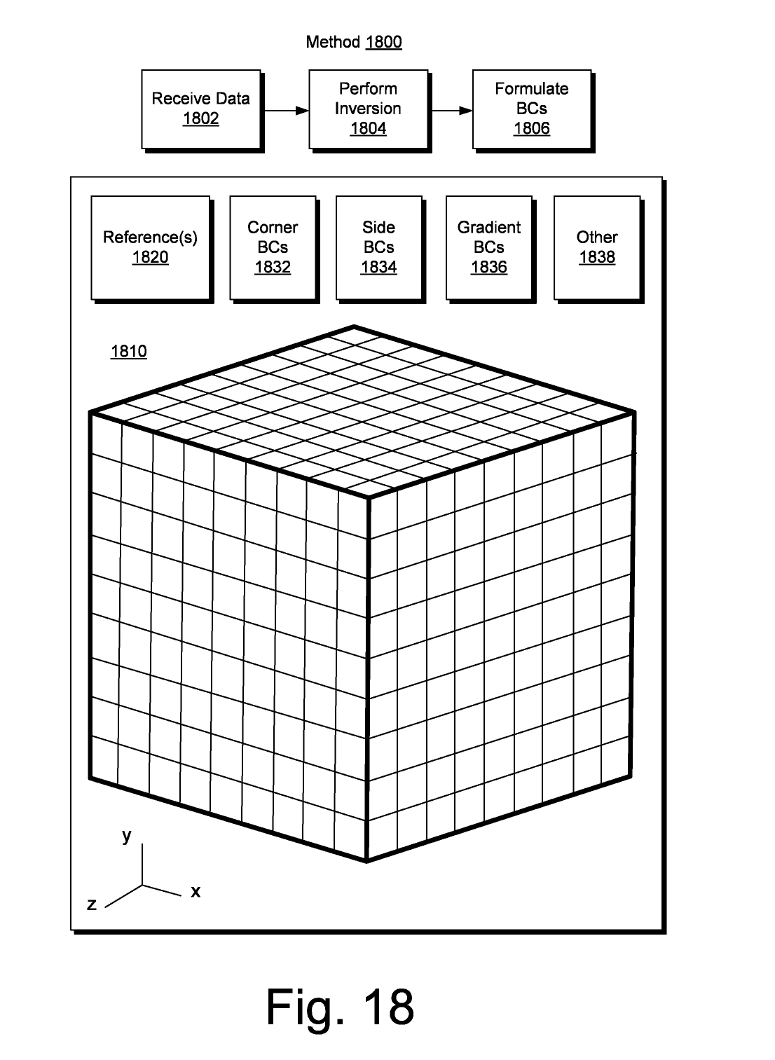

FIG. 18 shows an example of a method 1800, an example of model 1810 and various blocks 1820, 1832, 1834, 1836 and 1838 associated with one or more references and one or more boundary conditions.

The method 1800 includes a reception block 1802 for receiving data, a performance block 1804 for performing an inversion and a formulation block 1806 for formulating one or more boundary conditions.

As shown in FIG. 18, a model 1810 can be specified with respect to one or more references 1820, one or more corner boundary conditions 1832, one or more side boundary conditions 1834, one or more gradient boundary conditions 1836 and/or one or more other types of boundary conditions 1838.

In the model 1810, the sides are shown as being flat and planar, noting that the sides may include variations from flat. In the example of FIG. 18, a spatial reference may be defined for the model 1810. Such a spatial reference may be utilized to define strain values for the model 1810.

As an example, a method can include prescribing strain as a strain gradient with respect to a dimension such as depth (e.g., the y direction in the x, y, z Cartesian coordinate system of FIG. 18).

As an example, boundary conditions may be prescribed for a model where a bottom face or bottom side (e.g., bottom nodes) are constrained such that they do not move vertically. As an example, boundary conditions may be prescribed for a model where at least a portion of nodes of the model can move at least in part vertically (e.g., in the y direction in the x, y, z Cartesian coordinate system of FIG. 18). As an example, Earth's gravity may cause a model to compact, for example, due to the given weight of the model.

As an example, conditions can be prescribed for a model such that a bottom surface of the model is static (e.g., stationary) in a vertical direction while a top surface can be at least in part free to move. In such an example, boundary conditions may be prescribed for lateral sides of the model, which may be or include displacement boundary conditions. As an example, a solver may be utilized to implement the finite element method (FEM) to solve for stress distribution in the model given imposed conditions. As an example, the solution from a solver can be an equilibrium state solution with equilibrium stress values. Such a solution can depend on properties assigned to the model and conditions imposed on the model. As explained with respect to FIG. 9, displacement boundary conditions (e.g., whether value based, gradient based, etc.) may be specified and may reduce effects at corners of the model (e.g., effects in stress values at corners of the model). As an example, displacement boundary conditions may result in a model with fewer degrees of freedom at its boundaries when compared to stress boundary conditions.

As an example, a method can include performing an inversion to provide values for strain. For example, a method can include performing an inversion based at least in part on stress measurements or stress indicators (e.g., stress or stress-related information), which may be associated with a well, wells, etc. In such an example, the inversion can solve for strain parameter values such as, for example, εₕ, ε_{H} and azimuth (see, e.g., the GUI 1010 of FIG. 10).

As an example, referring to the 1D data of FIG. 4, at least a portion of the values therein may be utilized to perform an inversion for values for strain. As mentioned, the values in FIG. 4 may be based at least in part on information such as the information in FIG. 5.

As an example, a reference can be a point that is fixed with respect to a coordinate system such that it does not move laterally where, for example, it can move vertically as the model compacts under-weight, though on the bottom it could be fixed vertically. For example, a corner of a model may be set to be a reference that is a fixed point that is not displaced by deformation. As an example, a top corner of a model may be selected as a fixed reference point.

As an example, a displacement boundary condition may be specified as a displacement that occurs in a plane of a coordinate system. For example, consider displacement that occurs in an x,z-plane of the x, y, z Cartesian coordinate system of the model 1810 of FIG. 18. In such an example, a displacement is set to a prescribed amount for a node or nodes. In such an example, displacement may occur for such a node in a vertical direction (e.g., direction of gravity), for example, due at least in part to mass of material.

As an example, a method can include prescribe an amount or amounts of deformation for a shape that is to deform from a first state to a second state. In such an example, at least one boundary of the shape can deform (e.g., move).

As an example, displacement type boundary conditions may be employed with the DYNEL™ framework (Schlumberger Limited, Houston, Tex.), which may act to model a geologic environment in time (e.g., backward in time as to an unfolded state). As an example, displacement type boundary conditions may be employed with the PETROMOD® framework.

As an example, displacement type boundary conditions may be implemented for a grid associated with the MANGROVE® framework. For example, a workflow can include analyzing a geologic environment before, during and/or after a stimulation treatment such as, for example, a hydraulic fracturing treatment. As an example, a model may be built and used by a finite element solver to output stress information. In such an example, a portion of the model may be analyzed with respect to a stimulation treatment. As an example, a portion of the model may be remeshed or refined and information associated with the model utilized to perform a simulation of physical phenomena germane to a stimulation treatment.

As an example, a coordinate system may be a Cartesian coordinate system, a cylindrical coordinate system, a spherical coordinate or optionally another type of coordinate system. As an example, a coordinate system can include a dimension that is substantially aligned with a direction of Earth's gravity. For example, such a dimension may be a vertical dimension. As an example, boundary conditions as to lateral sides of a model may be specified horizontally, for example, in a plane or planes that may correspond to layers of rock. As an example, in a spherical coordinate system, horizons may be shells or portions of shells. In such an example, displacement boundary conditions may specify an amount of displacement along a surface of a shell where such a shell may be at least in part fixed and/or at least in part free to be displaced vertically.

As an example, a method can include selecting a region of interest in a geologic environment and modeling at least the region of interest. In such an example, a resulting model can include additional material (e.g., regions) that are proximate to (e.g., adjacent to) the selected region of interest. For example, consider an overburden region that is above the region of interest and/or one or more side burdens that are adjacent laterally to a region of interest. As an example, such regions may be chosen, sized, etc. based at least in part on the type of boundary conditions imposed on the model with respect to a system of equations that can be solved using a solver (e.g., a FEM solver). For example, where stress boundary conditions are implemented, the size of adjacent lateral burdens may be selected to be of the order of three times a dimension of the region of interest. Such an approach may aim to reduce edge effects at the region of interest. For example, consider the plot 910 of FIG. 9 where corner effects are shown where stress boundary conditions have been imposed. In such an example, to mitigate the impact of such effects on a region of interest within a model, the amount of side burden can be increased. As to displacement boundary conditions, as shown in the plot 930, they may reduce such edge effects, for example, as they can reduce the number of degrees of freedom at one or more boundaries of a model compared to stress boundary conditions.

As an example, a method can include gravity loading of a model where at an instant in time the model is subjected to gravity and a solution determined as to deformation of the model due at least in part to gravity. Such a solution may progress from an initial state to a compacted state. In such an example, the solution can provide information as to how much compaction has occurred. As an example, a solution may provide a mass or weight of a model.

As an example, a method can perform an initialization process where such a process includes gravity loading. As an example, a result of such a process can be a model that can be utilized for simulation, for example, as to production of fluid from a reservoir, injection of fluid, a stimulation treatment, etc.

As an example, a method can include receiving a model of a geologic environment; imposing displacement boundary conditions on at least one boundary of the model; and solving for equilibrium stress for the model subject to the displacement boundary conditions.

In such an example, the displacement boundary conditions can be imposed on at least one lateral boundary of the model that is between a bottom face and a top face of the model. As an example, a solution provided by a method may provide a base case for further simulation (e.g., as to one or more physical phenomena).

As an example, displacement boundary conditions can include a gradient displacement boundary condition. For example, a gradient displacement boundary condition can specify a displacement gradient with respect to a spatial dimension or spatial dimensions (e.g., a span). As an example, displacement boundary conditions can include a displacement function boundary condition. For example, consider a function that depends on a spatial dimension such as depth. In such an example, depth values may be input and displacements output where such displacements may be imposed on one or more lateral sides, corners, etc. of a model (e.g., one or more boundaries of the model).

As an example, displacement boundary conditions can specify at least one displacement value for horizontal displacement of at least a portion of at least one boundary of a model. As an example, horizontal displacement can be displacement that is in a direction other than a depth direction, for example, a direction that is substantially aligned with the direction of Earth's gravity.

As an example, displacement boundary conditions can specify amounts of displacement for at least some corners of a model. For example, consider displacement boundary conditions for two or more corners of a model where the two or more corners can be at a common depth. As an example, consider displacement boundary conditions for three corners of a four corner cross-section through a model at a substantially constant depth. In such an example, the fourth corner may be a reference point and displacements may be defined at least in part via the reference point. As an example, displacement amounts, angles, etc. may depend at least in part on a distance from a reference point.

As an example, a method can include using a model that includes cells defined by nodes, where at least a portion of the nodes are boundary nodes and where displacement boundary conditions are imposed as horizontal displacements specified by at least one final surface as a solution destination for at least a portion of the boundary nodes. In such an example, the model can include lateral sides where the at least one final surface includes a final surface for each of the lateral sides. For example, where a model includes four lateral sides, a top face and a bottom face, individual final surfaces may be prescribed for each of the four lateral sides where nodes that define the lateral sides are displaced via a solver such that a solution of the solver provides coordinates for the nodes and where those coordinates are on respective ones of the final surfaces.

As an example, a method can include utilizing a reference where at least one displacement boundary condition specifies at least one displacement that is defined with respect to the reference.

As an example, a reference can be or include a reference point that is fixed horizontally. As an example, a reference point may be fixed horizontally and fixed vertically.

As an example, a method can include utilizing a model that includes cells defined by nodes. In such an example, at least a portion of the nodes can be boundary nodes. In such an example, horizontal displacements can be assigned as displacement boundary conditions to at least some of the boundary nodes. For example, horizontal displacements may be assigned explicitly as displacement values or, for example, implicitly as line values where a node is to move (e.g., be displaced to) a line. As to the latter, the line may be defined by a first node that has an explicit displacement value and a second node that has an explicit displacement value where the line extends between the first node and the second node. In such an example, nodes intermediate to the first node and the second node may move relatively freely as long as their final positions are on the line.

As an example, a method can include performing an inversion based at least in part on measured data to determine at least one displacement value. In such an example, the method can include imposing at least one of the at least one displacement value as a displacement boundary condition value.

As an example, a model can include dimensions in a three-dimensional coordinate system where the coordinate system includes a depth dimension substantially aligned with a direction of Earth's gravity. In such an example, displacement boundary conditions can be imposed horizontally. As an example, one or more displacement boundary conditions can be specified as a function with respect to a depth dimension.

As an example, displacement boundary conditions can be based at least in part on two strain values and based at least in part on one azimuth value.

As an example, a system can include a processor; memory operatively coupled to the processor; and instructions stored in the memory and executable by the processor to instruct the system and where the instructions include instructions to: receive a model of a geologic environment; impose displacement boundary conditions on at least one boundary of the model; and solve for equilibrium stress for the model subject to the displacement boundary conditions. In such an example, the system can include instructions stored in memory and executable by the processor to instruct the system to determine one or more of the displacement boundary conditions based at least in part on two strain values and based at least in part on one azimuth value. As an example, a system can include a display and instructions stored in memory and executable by the processor to instruction the system to render information to the display. For example, a system may render a first model graphically to a display and a second deformed model graphically to the display (e.g., a deformed version of the first model). As an example, a system may render one or more graphical user interfaces to a display, for example, for entry of information such as strain information that can be utilized in computations for determining boundary conditions such as one or more types of displacement boundary conditions.

As an example, one or more computer-readable storage media can include computer-executable instructions to instruct a computing system where the instructions include instructions to: receive a model of a geologic environment; impose displacement boundary conditions on at least one boundary of the model; and solve for equilibrium stress for the model subject to the displacement boundary conditions. In such an example, the instructions can include computer-executable instructions to instruct a computing system to determine one or more of the displacement boundary conditions based at least in part on two strain values and based at least in part on one azimuth value.

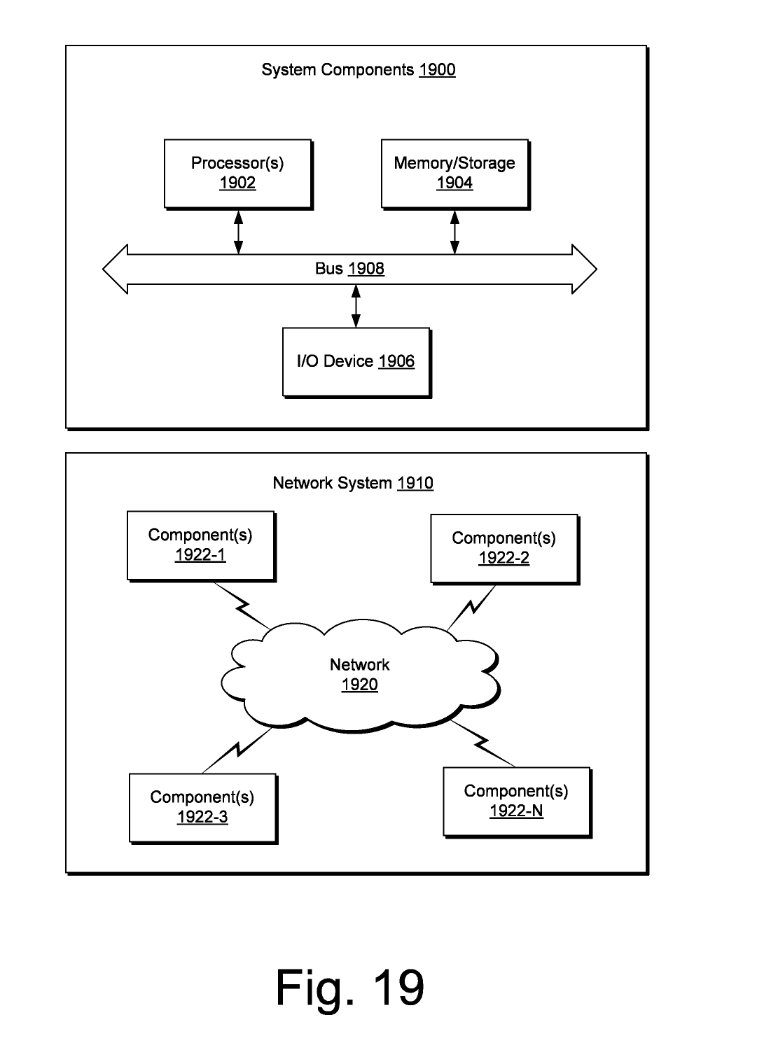

FIG. 19 shows components of an example of a computing system 1900 and an example of a networked system 1910. The system 1900 includes one or more processors 1902, memory and/or storage components 1904, one or more input and/or output devices 1906 and a bus 1908. In an example embodiment, instructions may be stored in one or more computer-readable media (e.g., memory/storage components 1904). Such instructions may be read by one or more processors (e.g., the processor(s) 1902) via a communication bus (e.g., the bus 1908), which may be wired or wireless. The one or more processors may execute such instructions to implement (wholly or in part) one or more attributes (e.g., as part of a method). A user may view output from and interact with a process via an I/O device (e.g., the device 1906). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1910. The network system 1910 includes components 1922-1, 1922-2, 1922-3, . . . , 1922-N. For example, the components 1922-1 may include the processor(s) 1902 while the component(s) 1922-3 may include memory accessible by the processor(s) 1902. Further, the component(s) 1902-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
receiving a model of a geologic environment;
imposing displacement boundary conditions on at least one boundary of the model; and
solving for equilibrium stress for the model subject to the displacement boundary conditions.

2. The method of claim 1 wherein the displacement boundary conditions are based at least in part on two strain values and based at least in part on one azimuth value.

3. The method of claim 1 wherein the displacement boundary conditions are imposed on at least one lateral boundary of the model that is between a bottom face and a top face of the model.

3. The method of claim 1 wherein the displacement boundary conditions comprise a gradient displacement boundary condition.

4. The method of claim 1 wherein the displacement boundary conditions comprise a displacement function boundary condition.

5. The method of claim 1 wherein the model comprises cells defined by nodes, wherein at least a portion of the nodes are boundary nodes and wherein horizontal displacements are assigned as displacement boundary conditions to at least some of the boundary nodes.

6. The method of claim 1 wherein the model comprises cells defined by nodes, wherein at least a portion of the nodes are boundary nodes and wherein the displacement boundary conditions comprise horizontal displacements specified by at least one final surface as a solution destination for at least a portion of the boundary nodes.

7. The method of claim 6 wherein the model comprises lateral sides and wherein the at least one final surface comprises a final surface for each of the lateral sides.

8. The method of claim 1 wherein the displacement boundary conditions specify amounts of displacement for at least some corners of the model.

9. The method of claim 1 comprising a reference wherein the displacement boundary conditions specify at least one displacement that is defined with respect to the reference.

10. The method of claim 9 wherein the reference comprises a reference point that is fixed horizontally.

11. The method of claim 9 wherein the reference comprises a reference point that is fixed horizontally and fixed vertically.

12. The method of claim 1 comprising performing an inversion based at least in part on measured data to determine at least one displacement value.

13. The method of claim 12 comprising imposing at least one of the at least one displacement value as a displacement boundary condition value.

14. The method of claim 1 wherein the model comprises dimensions in a three-dimensional coordinate system that comprises a depth dimension substantially aligned with a direction of Earth's gravity.

15. The method of claim 14 wherein the displacement boundary conditions are imposed horizontally.

16. The method of claim 14 wherein the displacement boundary conditions comprise a function with respect to the depth dimension.

17. A system comprising:
a processor;
memory operatively coupled to the processor; and
instructions stored in the memory and executable by the processor to instruct the system to:
receive a model of a geologic environment;
impose displacement boundary conditions on at least one boundary of the model; and
solve for equilibrium stress for the model subject to the displacement boundary conditions.

18. The system of claim 17 comprising instructions stored in the memory and executable by the processor to instruct the system to determine one or more of the displacement boundary conditions based at least in part on two strain values and based at least in part on one azimuth value.

19. One or more computer-readable storage media that comprise computer-executable instructions to instruct a computing system wherein the instructions comprise instructions to:
receive a model of a geologic environment;
impose displacement boundary conditions on at least one boundary of the model; and
solve for equilibrium stress for the model subject to the displacement boundary conditions.

20. The one or more computer-readable media of claim 19 wherein the instructions comprise computer-executable instructions to instruct a computing system to determine one or more of the displacement boundary conditions based at least in part on two strain values and based at least in part on one azimuth value.
